(19) United States
(12) Patent Application Publication
(10) Pub. No.: US 2018/0320868 A1
(43) Pub. Date: Nov. 8, 2018

(54) CLIP LIGHTS AND RELATED SYSTEMS

(71) Applicant: Gemmy Industries Corp., Coppell, TX (US)

(72) Inventors: Lio Yenwei Chang, Lewisville, TX (US); Cheng-Chun Zhang, Shenzhen City (CN)

(21) Appl. No.: 15/599,165

(22) Filed: May 18, 2017

Related U.S. Application Data
(63) Continuation-in-part of application No. 15/589,507, filed on May 8, 2017.

(51) Int. Cl. F21V 21/088; F21V 5/04; F21V 3/00; F21V 17/02; F21V 23/00; H05B 37/02; H05B 33/08; F21S 4/10; F21V 31/00; E04D 13/00

(52) U.S. Cl. CPC F21V 21/088; F21V 5/045; F21V 3/00; F21V 17/02; F21V 23/001; F21Y 2115/10; H05B 33/0863; F21S 4/10; F21V 31/005; E04D 13/00; H05B 37/0272

(57) ABSTRACT

A clip light can include a clip having a first clamp member and a second clamp member that opposes the first clamp member, wherein the first clamp member and the second clamp member are elastically biased towards one another; a light emitting diode located on the first clamp member; and a light unit cover that encloses the light emitting diode. A lighting system can include: a plurality of clip lights arranged into a light string by wires; a power adapter that transmits power to the plurality of clip lights through the wires and a set of wires that connects the plurality of clip lights to the power adapter.

### TECHNICAL FIELD

This patent application relates generally to lighting systems and components. More specifically, this patent application relates to clip on lighting systems and components, for example, for use in or around a building, such as a house, or surrounding structures.

### BACKGROUND

Lighting systems are commonly used for decorative or environmental purposes. For example, during the holidays, people often place electric lights on their houses or landscaping surrounding their houses. These lights typically consist of one or more lengths of conductive wire, each length of wire having multiple lights (e.g., light bulbs) distributed there along. The lengths of wire and/or lights can be secured to the house, landscaping, or other object in various ways, such as by wrapping the wire around the object, or using fasteners such as nails or tacks.

### SUMMARY

In an embodiment, a clip light can include a clip having a first clamp member and a second clamp member that opposes the first clamp member, wherein the first clamp member and the second clamp member are elastically biased towards one another; a light emitting diode located on the first clamp member; and a light unit cover that encloses the light emitting diode.

In an embodiment, a lighting system can include: a plurality of clip lights that include a clip having a first clamp member and a second clamp member that opposes the first clamp member, wherein the first clamp member and the second clamp member are elastically biased towards one another; a light emitting diode located on the first clamp member; and a light unit cover that encloses the light emitting diode. The plurality of clip lights can be arranged into a light string by wires. The lighting system can include a power adapter that transmits power to the plurality of clip lights through the wires and a set of wires that connects the plurality of clip lights to the power adapter.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a perspective view of a clip light in a relaxed state, according to a first embodiment of the invention.

FIG. 2 depicts an exploded view of the clip light of FIG. 1.

FIG. 3 depicts a perspective view of a clip light in an expanded state, according to the first embodiment of the invention.

FIG. 4A depicts a perspective view of a string of clip lights, according to the first embodiment of the invention.

FIG. 4B depicts a perspective view of a string of clip lights mounted to an eaves, according to the first embodiment of the invention.

FIG. 4C depicts a side, partially cross-sectional view of a clip light mounted to an eaves, according to the first embodiment of the invention.

FIG. 4D depicts a perspective view of a light system including a plurality of clip lights, according to the first embodiment of the invention.

FIG. 5 depicts a perspective view of a string of clip lights being connected to an eaves, according to the first embodiment of the invention.

FIG. 6 depicts a perspective view of a clip light in a relaxed state, according to a second embodiment of the invention.

FIG. 7 depicts an exploded view of a clip light according to the second embodiment of the invention.

FIG. 8 depicts a perspective view of a clip light in an expanded state, according to the second embodiment of the invention.

FIG. 9 depicts a perspective view of a string of clip lights in a relaxed state and an expanded state, according to the second embodiment of the invention.

FIG. 10 depicts a perspective view of a string of clip lights connected to an eaves, according to the second embodiment of the invention.

FIG. 11 depicts a perspective view of a string of clip lights being connected to an eaves, according to the second embodiment of the invention.

FIG. 12 depicts a perspective view of a clip light, according to a third embodiment of the invention.

FIG. 13 depicts an exploded view of a clip light, according to the third embodiment of the invention.

FIG. 14 depicts a string of clip lights in a relaxed state and in an expanded state, according to the third embodiment of the invention.

FIG. 15 depicts a front view of a string of clip lights connected to an eaves, according to the third embodiment of the invention.

FIG. 16 depicts a perspective view of a string of clip lights being connected to an eaves, according to the third embodiment of the invention.

FIG. 17 depicts a perspective view of a clip light, according to a fourth embodiment of the invention.

FIG. 18 depicts an exploded view of a clip light, according to the fourth embodiment of the invention.

FIG. 19 depicts a perspective view of a string of clip lights in a relaxed state and in an expanded state, according to the fourth embodiment of the invention.

FIG. 20 depicts a front view of a string of clip lights connected to an eaves, according to the fourth embodiment of the invention.

FIG. 21 depicts a perspective view of a string of clip lights being connected to an eaves, according to the fourth embodiment of the invention.

FIG. 22 depicts an exploded view of a clip light, according to a fifth embodiment of the invention.

FIG. 23 depicts an exploded view of a clip light, according to a sixth embodiment of the invention.

FIG. 24 depicts a perspective view of a clip light, according to a seventh embodiment of the invention.

FIG. 25 depicts an exploded view of a clip light, according to the seventh embodiment of the invention.

FIG. 26 depicts a perspective view of a string of clip lights, according to the seventh embodiment of the invention.

FIG. 27 depicts a perspective view of a clip light, according to an eighth embodiment of the invention.

FIG. 28 depicts an exploded view of a clip light, according to the eighth embodiment of the invention.

FIG. 29 depicts a perspective view of a string of clip lights, according to the eighth embodiment of the invention.

FIG. 30 depicts a front view of a string of clip lights connected to an eaves, according to the eighth embodiment of the invention.

FIG. 31 depicts a perspective view of a string of clip lights being connected to an eaves, according to the eighth embodiment of the invention.

FIG. 32 depicts a side view of a clip light, according to a ninth embodiment of the invention.

FIG. 33 depicts a perspective view of a clip light, according to the ninth embodiment.

FIG. 34 depicts a perspective view of a clip light with a rotated light, according to the ninth embodiment, shown with the light rotated into a different position than FIGS. 32 and 33.

FIG. 35 depicts a bottom-right perspective view of FIG. 34.

FIG. 36 depicts an exploded view of the clip light of FIG. 32.

FIG. 37 depicts a perspective view of a string of clip lights being connected to an eaves, according to the ninth embodiment.

FIG. 38 depicts a side view of a clip light, according to a tenth embodiment of the invention.

FIG. 39 depicts a perspective view of a clip light, according to the tenth embodiment.

FIG. 40 depicts a side view of a clip light, according to the tenth embodiment, shown with the light rotated into a different position than FIGS. 38 and 39.

FIG. 41 depicts a bottom-right perspective view of FIG. 40.

FIG. 42 depicts an exploded view of the clip light of FIG. 38.

FIG. 43A depicts a perspective view of a string of clip lights being attached to an eaves, according to the tenth embodiment.

FIG. 43B depicts a perspective view of a portion of a clip light with the lens removed to reveal internal components, according to the tenth embodiment.

FIG. 44 depicts a perspective view of a clip light, according to an eleventh embodiment.

FIG. 45 depicts a perspective view of a clip light, according to the eleventh embodiment, shown with the light rotated into a different position than FIG. 44.

FIG. 46 depicts a top-left perspective view of FIG. 45.

FIG. 47A depicts an exploded view of the clip light of FIG. 44.

FIG. 47B depicts another exploded view of the clip light of FIG. 44.

FIG. 48 depicts an opposing view of FIG. 47A.

FIG. 49 depicts a perspective view of a string of clip lights being connected to an eaves, according to the eleventh embodiment.

FIG. 50 depicts a perspective view of a clip light, according to a twelfth embodiment.

FIG. 51 depicts a side view of a clip light, according to the twelfth embodiment, shown with the light rotated to a different position than the light in FIG. 50.

FIG. 52 depicts a perspective view of FIG. 51.

FIG. 53 depicts an exploded view of the clip light of FIG. 50.

FIG. 54 depicts a perspective view of a string of clip lights, according to the twelfth embodiment.

FIG. 55 depicts a perspective view of a clip light, according to a thirteenth embodiment.

FIG. 56 depicts an exploded view of the clip light of FIG. 55.

FIG. 57 depicts a perspective view of a string of clip lights, according to the thirteenth embodiment.

FIG. 58 depicts a front view of a string of clip lights connected to an eaves, according to the thirteenth embodiment.

FIG. 59 depicts a perspective view of a string of clip lights being connected to an eaves, according to the thirteenth embodiment.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without departing from the spirit and scope of the invention. It is to be understood that each specific element includes all technical equivalents that operate in a similar manner to accomplish a similar purpose. The examples and embodiments described herein are non-limiting examples.

The present application relates to a decorative lighting system including a string of light modules, or “clip lights” that can be easily clipped on and off of a house or other structure. Multiple strings of the lights can be connected together in series and/or parallel in order to provide a scalable system. A control system, either hardwired into one or more of the strings, or provided remotely, can be used to set various colors and illumination patterns, as may be desired by the user, for example, to provide various holiday themes. Embodiments of the system are described below. It will be understood by one of ordinary skill in the art, based on this disclosure, that features described in connection with one embodiment may be used with other embodiments.

### First Embodiment

As shown in FIG. 1, a clip light 100 can include a clip 102 having a first clamp member 110a and a second clamp member 110b that opposes the first clamp member 110a. The first and second clamp members 110a, 110b can be resilient jaw portions that are biased towards each other, for example, elastically. This may be accomplished, for example, by forming the clamp members 110a, 110b from elastic materials, such as spring steel. The first and second clamp members 110a, 110b can be independently formed or can be integrally joined, for example, by a connecting base 150. The first and second clamp members 110a, 110b can be biased towards one another, for example, in an inwardly angled orientation. According to embodiments, the clip 102 can have a cross-section substantially in the shape of an isosceles triangle with the first and second clamp members 110a, 110b making up the legs of substantially equal length and the connecting base 150 making up the base of the triangle. Tension along the first and second clamp members 110a, 110b, and/or the connecting base 150 can bias the two sides to make contact one with another. Thus, in a relaxed state the first and second clamp members 110a, 110b can extend along planes that are not parallel to each other. The clip 102 can be made of metal, plastic, composite material, or any other durable and resilient material.

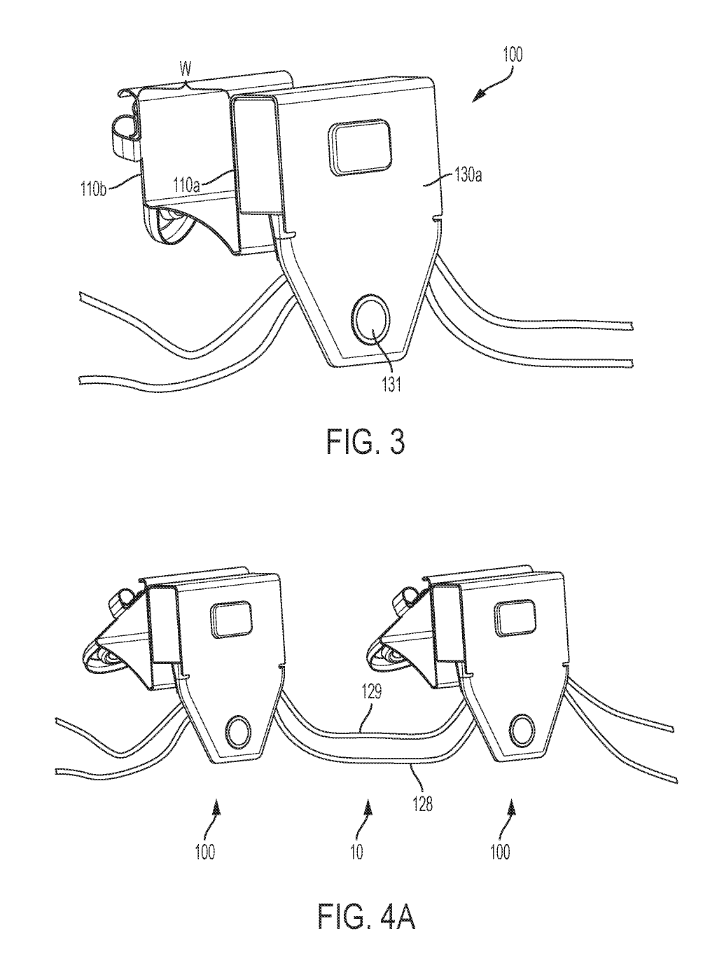

The clip 102 can include first and second exterior plates 130a, 130b that are connected to the first and second clamp members 110a, 110b, respectively. For example, the first and second exterior plates 130a, 130b can be bonded, welded, or fastened to the clamp members 110a, 110b, or alternatively, can be formed integrally therewith. The first and second exterior plates 130a, 130b can cover the exterior of the first and second clamp members 110a, 110b, respectively. The first and second exterior plates 130a, 130b each can have a height that is greater than a height of the first and second clamp members 110a, 110b, respectively. For example, the first and second exterior plates 130a, 130b can each have handle portions 132a, 132b that extend below the first and second clamp members 110a, 110b, respectively. The handle portions 132a, 132b can serve as levers in the positions indicated in FIG. 1 to allow the user to use his or her fingers to spread the first and second clamp members 110a, 110b apart from one another, for example, to the position shown in FIG. 3. When an inward pressure is applied on the handle portions 132a, 132b, they can spring the clip 102 open. Releasing the inward pressure, and/or applying outward pressure can allow the clamp members 110a, 110b to elastically spring back toward one another.

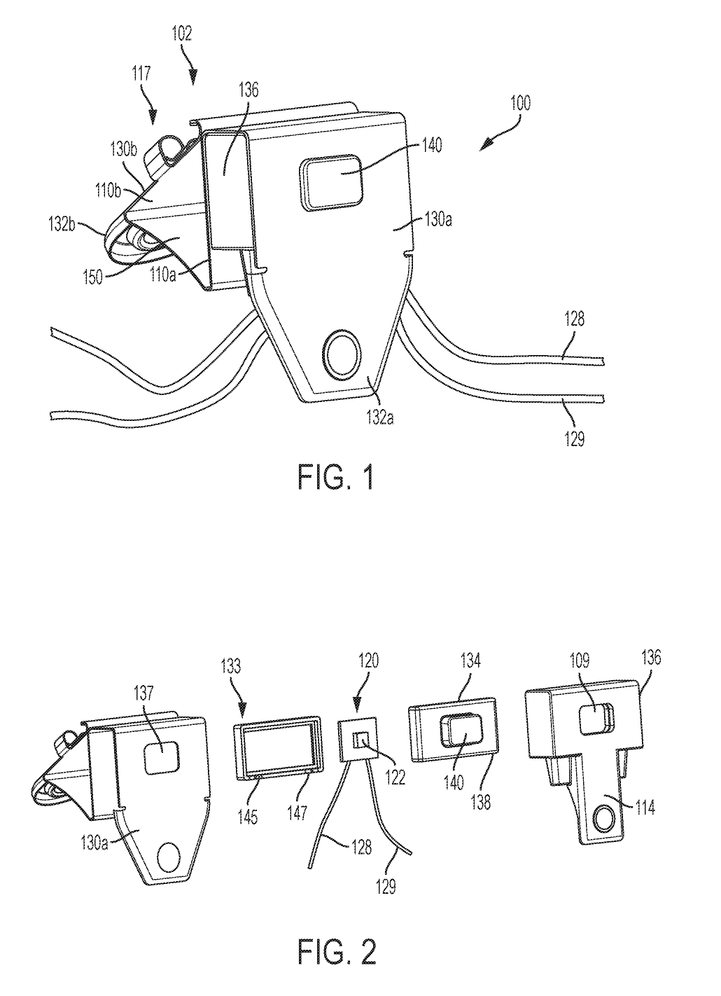

The clip 102 can be configured to attach to a roof board, for example, with the clamp members 110a, 110b on opposite sides of the board. The clip light 100 can include a light unit 120 (see FIG. 2) provided on at least one of the first and second clamp members 110a, 110b.

As shown in FIG. 1, one or more loops 117 can be disposed on an edge of clamp member 110b. The hook 117 can allow a neat and orderly organization of the wires 128, 129 and clip lights 100 when in a string of clip lights.

As can be seen from FIG. 1, a housing 136 can be positioned in between first clamp member 110a and first exterior plate 130a. The housing 136 can include a vertical support 114 (FIG. 2) that can interface with the handle portion 132a of the first exterior plate 130a. The housing 136 can thus provide for a more stable opening of the clip 102. Additionally, the housing 136 can enclose the light unit 120 and other electrical components, as will be described in more detail below.

As shown in FIG. 3, the clip light 100 in the expanded state can have the first and second clamp members 110a, 110b extend along planes that are substantially parallel to each other. The distance between the clamp members 110a, 110b in the expanded state is represented by W and can correspond to the maximum width of the structure to which the clip light 100 can attach, for example, without permanently deforming the clip.

Referring to FIG. 2, the housing 136 can house the light unit 120. The light unit 120 can comprise one or more light emitting diodes (LEDs) 122 or laser diodes (LDs), or other light sources, such as miniature incandescent bulb(s). The light unit 120 can have one or more electrical wires 128, 129 connected thereto. The LED 122 can be a surface mounted LED, as shown, however, other types of LEDs are contemplated such as chip-on-board or multiple chip-on-board LEDs. The LEDs can be multi-color RGB LEDs and configured to emit a variety of colors. Alternatively, the LEDs can be white LEDs. The housing 136 can also house a light unit cover 134, which can be made of a bottom light unit cover 133 and an upper light unit cover 138. The light unit cover 134 can be a weather resistant clamshell housing that can be completely transparent or translucent, or can be opaque with a transparent or translucent window 140. The light unit cover 134 can house a circuit board (such as a printed circuit board) supporting the light unit 120 in electrical connection with the wires 128, 129. The bottom light unit cover 133 can also contain a heat sink (not shown) in thermal communication with the circuit board, such that the heat sink draws heat away from the circuit board and light unit 120, to maintain an acceptable temperature for the electrical components. According to embodiments, the heat sink can be formed of metal, such as aluminum alloy, copper, composites, or combinations thereof. The heat sink can also include fins (not shown) or other features configured to further draw heat away from the circuit board.

The light unit covers 133, 138 can together define one or more grooves or recesses 145, 147 for wires 128, 129 to extend from the light unit cover 134 to outside the clip 102. As mentioned previously, the upper light unit cover 138 can include a window 140 that projects above the top surface of the upper light unit cover 138. The window 140 can be made of a transparent or translucent material that allows light from the light unit 120 to be transmitted therethrough. As shown in FIG. 2, the housing 136 can define a hole 109 that allows for the window 140 to extend through. In addition, the first exterior plate 130a can define an aperture 137 that similarly allows for the window 140 to extend through or that allows for light from the light unit 120 to be transmitted outwardly. According to an embodiment, window 140 projecting through the hole 109 and aperture 137 can retain the housing 136 on the first clamp member 110a. Alternatively, adhesives or fasteners can be used to retain the housing 136 on the first clamp member 110a. The light unit cover 134 can be made of hard plastic, metal, composite, or other durable material. As shown in FIG. 3, a finger grip pad 131 can be provided on the first exterior plate 130a. A similar structure can be provided on the second exterior plate 130b.

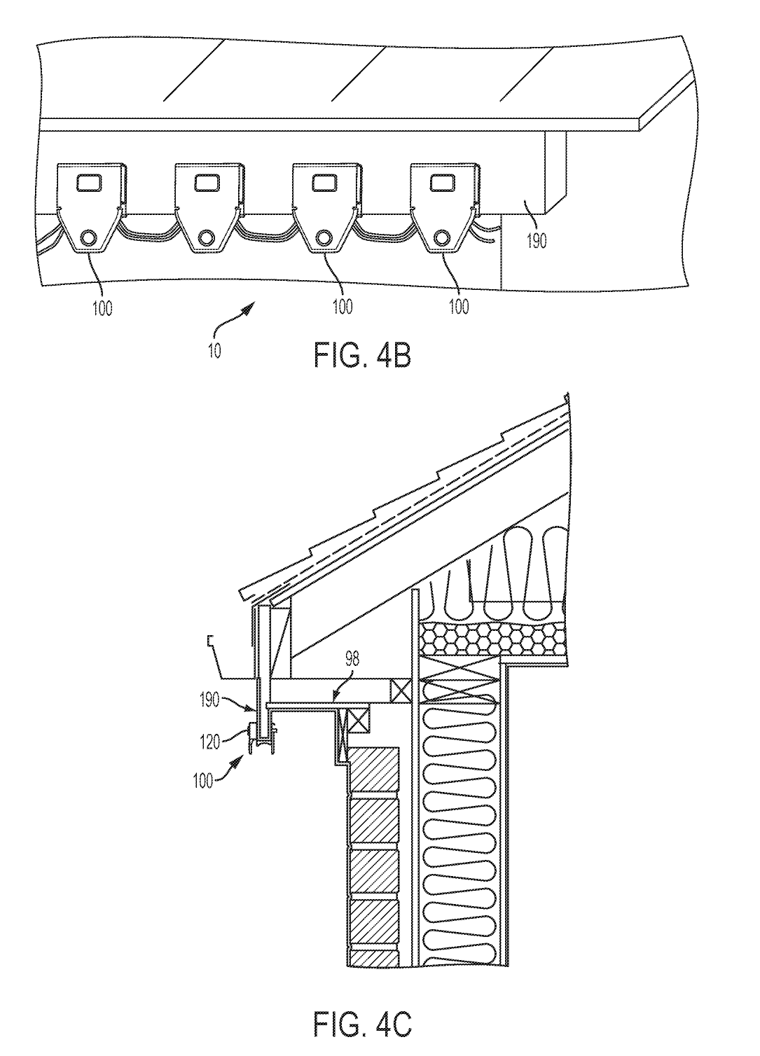

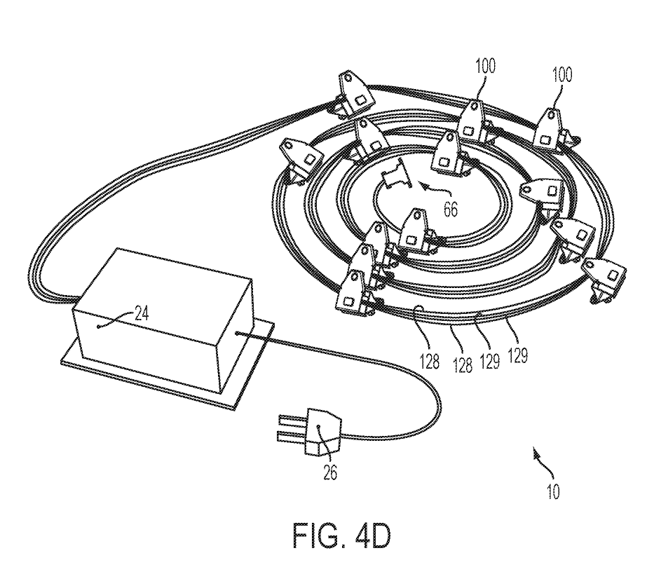

According to an embodiment, as shown in FIG. 4A, a lighting system 10 can include a plurality of clip lights 100 connected in series, for example, by wires 128, 129. For example, the lighting system 10 can include 2, 3, 4, 5, 10, 15, 20, or any number of clip lights 100 as may be desirable for a particular application. FIG. 4A depicts an embodiment of lighting system 10 detached from a building or other object. The lighting system 10 can be attached to a structure, such as a fascia board 190, as shown in FIGS. 4B and 4C, although other structures that can fit within the clip are contemplated. FIG. 4B shows a plurality of clip lights 100 mounted to the fascia board 190 or in a suitable place; however, other mounting locations are possible. The housing and mounting clip can facilitate mounting the clip lights to the fascia or under the eave, or on some other structure, for extended periods of time.

FIG. 4C depicts a side profile view of the mounted clip light 100 on a fascia board 190 that can extend from a roof and/or soffit 98. The light unit 120 of the clip light 100 can project away from the structure to which the clip light 100 is attached.

As shown in FIG. 4D, the lighting system 10 can include a plurality of the clip lights 100 connected by the wires 128, 129, as described above. The system can also include a power adapter 24 that receives electrical power, for example, from a power supply 26, such as an AC plug or other connector adapted to plug into an electrical outlet, such as an 110V, 120V, 220V, or 240V AC outlet or an appropriate battery that provides power. The system can also include a controller (not shown) connected between the power adapter 24 and the string of clip lights 100. According to an alternative embodiment, the power adapter 24 and the controller can be integrated into a single unit. Mating cord couplers 66 can be provided to facilitate disconnecting and reconnecting the wires 128, 129 to the controller 24, and/or to facilitate connection of multiple strings of clip lights in an end-to-end arrangement, for example, to extend the length of the lighting system. According to embodiments, the cord couplers 66 can be weather resistant, e.g., they can form a water tight seal around the underlying electrical components. This can be accomplished, for example, by using couplers 66 having plastic or rubber material with mating threaded portions, or by using threaded metal couplers having a rubber gasket, O-ring, or the like. One of ordinary skill in the art will appreciate from this disclosure that other structures can be used to from a weatherproof connection between adjoined couplers 66, including those without threads.

A portable electronic device or handheld wireless remote can interface with the controller to adjust the lights, e.g., using Bluetooth, Wifi, IR, or other wireless technology. The controller can also be a portable electronic device (such as a smart phone) with a Bluetooth or Wifi connector, etc. In addition to the input buttons on the face of the controller, the portable electronic device can be configured to connect with the controller to operate all functions of the controller using the keys on the portable electronic device. The portable electronic device may connect to the controller using infrared or RF wireless transmission protocols and systems known in the art. Likewise, the controller may include other wireless communication hardware and firmware to allow the controller to receive control signals from a wireless device such as a smartphone, smart tablet, computer, or other computer based system having a processor, executable instructions (such as a smartphone app) and wireless communication capabilities. For such wireless communications, the wireless device can communicate with the controller using a wireless network and communicate through a wireless router such that the wireless device sends and receives signals from the controller through the wireless network router, such as a Wi-Fi router. Likewise, the wireless device can communicate directly with the controller if the wireless controller includes wireless communication hardware, such as a Wi-Fi or Bluetooth chip configured for direct communication with a handheld or other wireless device.

Thus, the lights can be wirelessly controlled to turn each on and off under the control of the built in controller, or a remote controller or smart device. The controller can be used to create different colors and/or illumination patterns. The controller can be programmed to provide a variety of user-selectable light shows, such as seasonal and/or year-round light shows. For example, according to embodiments, the user can scroll through a menu and select a light pattern they desire. Different lighting patterns can range from steady burn to light changing, color changing, blinking lights, chasing lights, and other patterns and sequences as may be desired by the user.

According to embodiments, lighting system 10 can include a distributor that allows multiple strings of lights 100 to branch off from the power adapter and/or controller, for example, in parallel. Accordingly, a series-parallel configuration is possible where multiple strings of series-connected clip lights 100 are connected in parallel. The distributor can be a stand-alone unit, or alternatively, the distributor can be integrated with the controller and/or the power adapter 24. The distributor can also be connected to the controller and/or power adapter 24 by removable connection, such as by weatherproof couplers 66 described above.

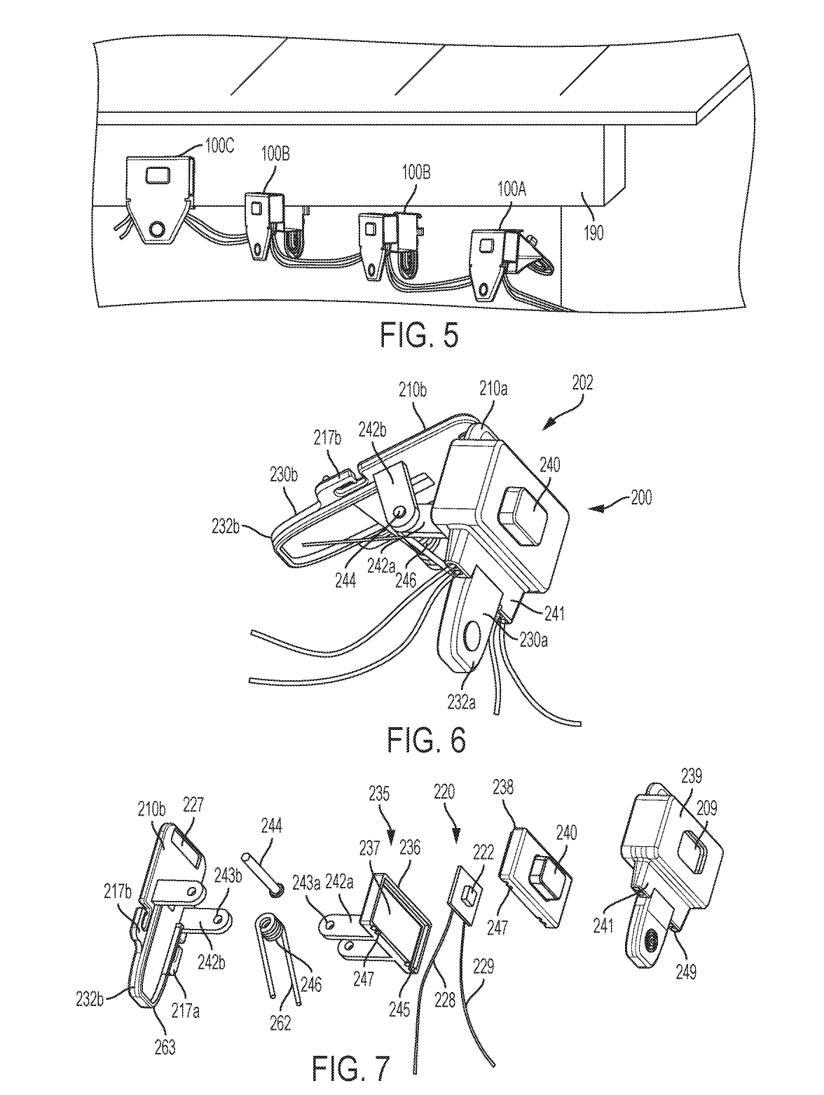

FIG. 5 shows the various stages of the clip light 100 being attached to a structure, for example, underneath the eaves of a roof. Clip light 100A is depicted in a relaxed state. Clip lights 100B are depicted in an expanded state. Clip light 100C is depicted gripping the structure 190.

### Second Embodiment

A second embodiment of a clip light according to the present invention is shown in FIGS. 6-11. As shown in FIGS. 6 and 7, the clip light 200 can comprise a clip 202 having first and second clamp members 210a, 210b. The clamp members 210a, 210b can each have extension arms 242a, 242b, respectively that each define a hole 243a, 234b. A pin 244 can extend through holes 243a, 243b (see FIG. 7) in the extension arms 242a, 242b to form a hinge between the first clamp member 210a and second clamp member 210b. The pin 244 can be retained in place using known structures, such as an interference fit, deformation, flared ends, bonding, or other feature. The clamp members 210a, 210b can be biased towards each other by means of a spring 246 disposed in between the two members. For example, spring 246 can comprise a torsion spring having its coil encircle the pin 244. The arms 262 of the spring 246 can push out against the clamp members 210a, 210b. The clamp members 210a, 210b can include an outer ridge 263 that keeps the spring arms 262 from slipping off the clamp members 210a, 210b. The pin 244 can be made of any sturdy and resilient material including metal, hard plastic, wood or a composite material. The clamp members 210a, 210b can be made of metal, plastic, composite material, or any other durable and resilient material.

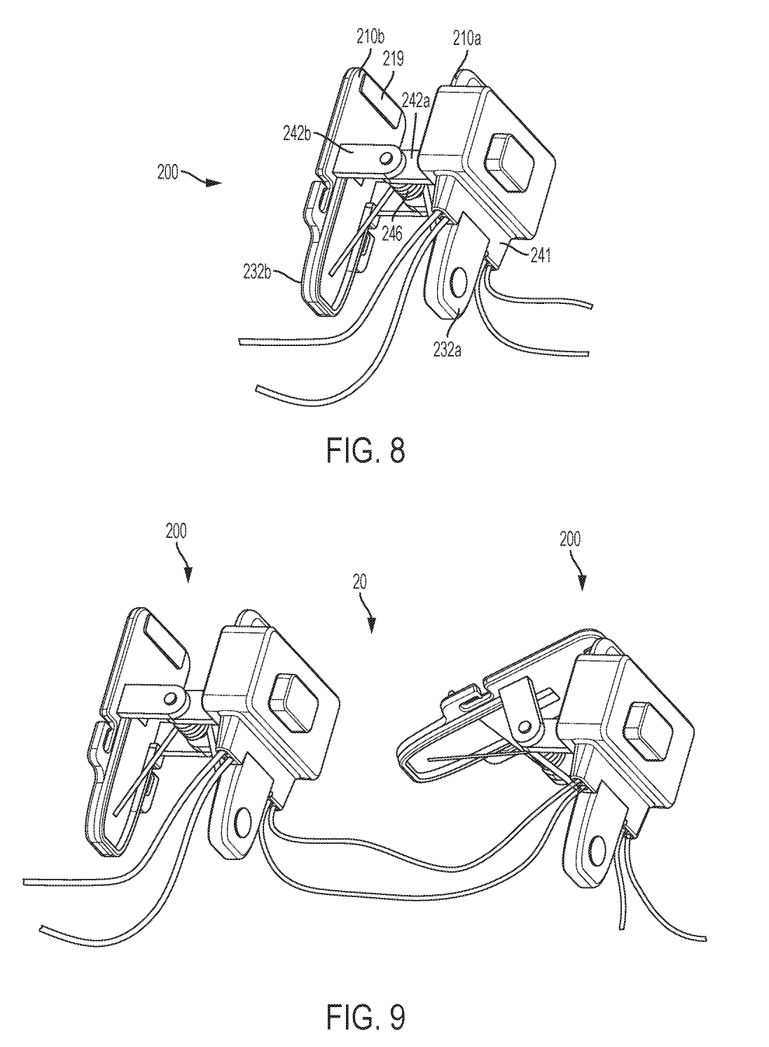

The functionality of opening the clip 202 can be similar to that described with respect to the clip light of the first embodiment. When pressure is applied to a lower portion 232a, 232b of the exterior surface 230a, 230b of the clamp members 210a, 210b, the clamp members pivot about the pin 244 against the force of the spring 246, and the top-most portion of the clamp members open, as shown in FIG. 8. Releasing pressure from the lower portions 232a, 232b allows the spring 246 to recoil, causing the clamp members 210a, 210b to clamp against one another, or against an object located therebetween. The clamp members 210a, 210b can be released from a structure by further applying pressure to the lower portions 232a, 232b of the clamp members 210a, 210b, which allows the user to free the clamp members 210a, 210b from contact with the structure.

As shown in FIG. 7, the first clamp member 210a can include a housing 235 defined by a light unit cover 236 and an upper light unit cover 238. The housing 235 can define a compartment 237 that can house the light unit 220. The light unit 220 can comprise a surface mounted LED 222 or other light source, similar to the light unit of the first embodiment. The bottom light unit cover 236 can define one or more grooves 245, 247 for wires 228, 229 to travel through. The upper light unit cover 238 can include a light window 240 that can protrude upward from the exterior surface of the upper light unit cover 238. The upper light unit cover 238 can define grooves 247 that can align with the grooves 245 of the bottom light unit cover 236. When the bottom and upper light unit covers 236, 238 are connected, the grooves can define apertures for wires 228, 229 to travel through. Clamp member 210a can include exterior housing 239 that can cover the housing 235. The exterior housing 239 can include a bottom portion 241 having apertures 249 (see FIG. 7) for wires 228, 229 to pass through. The bottom portion 241 can thus serve as an interface for the wires 228, 229 coming in and out of the clip light 200. In an embodiment, two apertures on a left side can allow for two wires to pass while two apertures on a right side can allow two wires to pass. This can allow for two wires to enter the exterior housing 239 and two wires to exit. Other embodiments are possible.

Clamp member 210a can include one or more hooks 217a, 217b that can receive one or more wires 228, 229 for a tidy and/or secure wire placement. For example, the hooks 217a, 217b can allow for the wires to be secured in the case where the clip lights 200 are positioned close to each other and there is slack.

An upper portion of the first and second clamp members 210a, 210b can include a recess 227 that can receive a friction-enhancing pad 219 (see FIG. 8) such as rubber or elastomer to provide a secure grip onto an object. As shown in FIG. 7, the exterior housing 239 can define a hole 209 that allows for window 240 to extend through, similar to the clip light of the first embodiment. According to an embodiment, window 240 projecting through hole 209 can retain the exterior housing 239 on the first clamp member 210a. Alternatively, adhesives or fasteners can be used to retain the exterior housing 239 on the first clamp member 210a.

Bottom and upper light unit covers 236, 238 can be made of any durable and resilient material such as, for example, hard plastic, metal, composite material, etc. Window 240 can be made of any durable yet transparent or translucent material that can shield the light unit from external elements, but still allow for light to be transmitted through. Light unit cover 238 can be formed monolithically with window 240, or alternatively, they can comprise two separate parts joined together. Both light unit cover 238 and window 240 can be transparent or translucent, or alternatively, the light unit cover 238 can be opaque while window 240 is transparent or translucent.

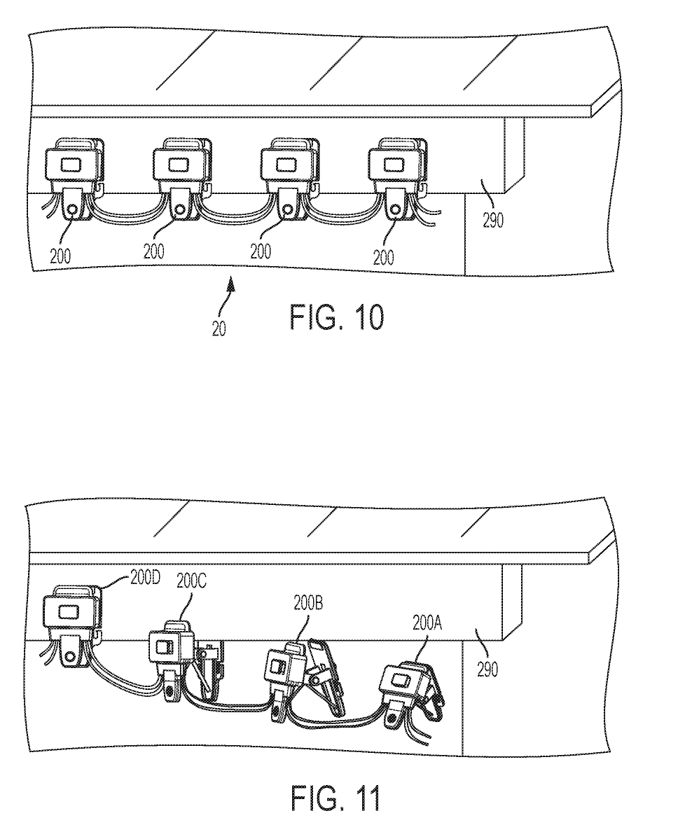

FIG. 8 shows clip light 200 in an open, expanded state. FIG. 9 shows a light system 20 having a string of clip lights 200 according to the second embodiment. FIG. 10 shows the light system 20 mounted to a structure 290. FIG. 11 shows the various stages of the clip light 200 going from a clip light 200A in a relaxed and closed state to a clip light 200B in a more expanded state, to a clip light 200C in an open state, and to a clip light 200D in a mounted state, where it is attached to fascia board 290.

The clip lights 200 can be connected into one or more strings, such as described in connection with the first embodiment. Illumination of the lights 200 can be controlled using a variety of different controllers electrically coupled to the lighting system, similar to the structures and functions disclosed with reference to the first embodiment.

### Third Embodiment

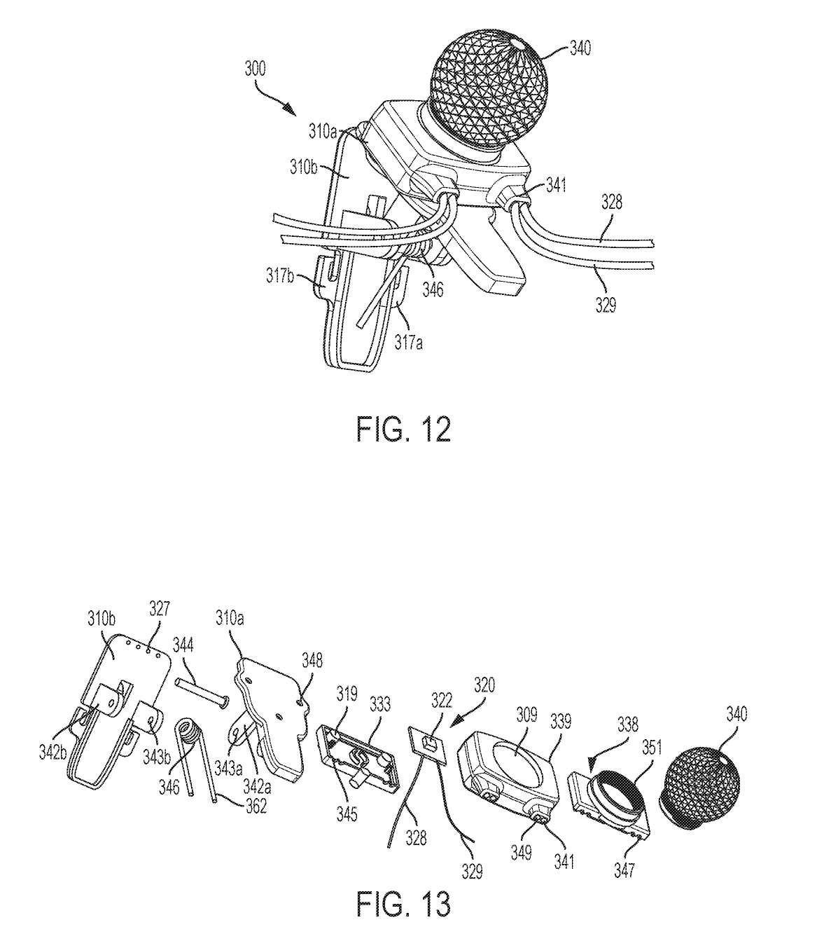

FIGS. 12-16 depict a third embodiment of a clip light 300. Similar to the second embodiment, and as shown in FIG. 13, a first clamp member 310a and an opposing second clamp member 310b can include extending arms 342a, 342b each having distal apertures 343a, 343b. A pin 344 can extend through the distal apertures 343a, 343b to create a hinge that connects the extending arms 342a, 342b of the first and second clamp members 310a, 310b. As with the second embodiment, an elastic member such as a torsion spring 346 can extend around the pin 344 and bias the clamp members 310a, 310b toward one another using its arms 362.

On a surface opposite the extension arms 342a, 342b, the first clamp member 310a can have a plurality of fastening locations (e.g., three) in the form of holes 348 for securing an exterior housing 339. The exterior housing 339 can be connected to the first clamp member through bottom light unit cover 333, for example, by having a fastener extend through holes 348 into bosses 319, however, other ways to fasten exterior housing 339 to first clamp member 310a, such as adhesive, are possible. The bottom light unit cover 333 can define grooves 345. The bottom light unit cover 333 can interface with an upper light unit cover 338 that can share complementary grooves 347 that cooperate with grooves 345 to permit passage of wires 328, 329. The exterior housing 339 can include apertures 341, 349 for the passage of wires 328, 329. The upper and lower light unit covers can house the light unit 320, which can comprise a light source 322, such as one or more LEDs or other light producing elements, similar to previous embodiments. The upper light unit cover 338 can include a lip 351 that is configured to receive a lens 340, such as a beam splitter kaleidoscope lens.

Hooks 317a, 317b can project away from at least one of the first and second clamping members. The hooks 317a, 317b can be configured to receive one or more wires 328, 329 for a tidy and/or secure wire placement.

The lens 340 can comprise a beam splitter that is substantially globe-shaped. The lens 340 can define a substantially hollow interior region. A plurality of facets can be distributed about the inner and/or outer surface of the lens 340, for example, in order to create a dimpled surface. The facets can focus the light from the light unit 320 into multiple individual beams. According to embodiments, the lens 340 can have a smooth surface, a textured surface, an irregular surface, or combinations thereof. Different surfaces can allow for different patterns for the emitted light. The lens 340 can be made of plastic, a hard plastic, glass, or other durable but translucent or transparent materials. The clamping members 310a, 310b, bottom unit light cover 333, and exterior housing 339 can be made of any durable and resilient material such as plastic, metal, composite, etc.

In an embodiment, the lip 351 of the upper light unit cover 338 can project through an aperture 309 in the exterior housing 339. The exterior housing 339 can house the upper and bottom light unit covers 333, 338, or at least a portion thereof.

The interior surface of the first and second clamp members 310a, 310b can include one or more friction-enhancing features, such as protuberances 327, that facilitate gripping to the item the clip attaches to. As shown, the protuberances can be located at a top-most portion of the interior surface of the first and second clamp members 310a, 310b, however, other locations are possible.

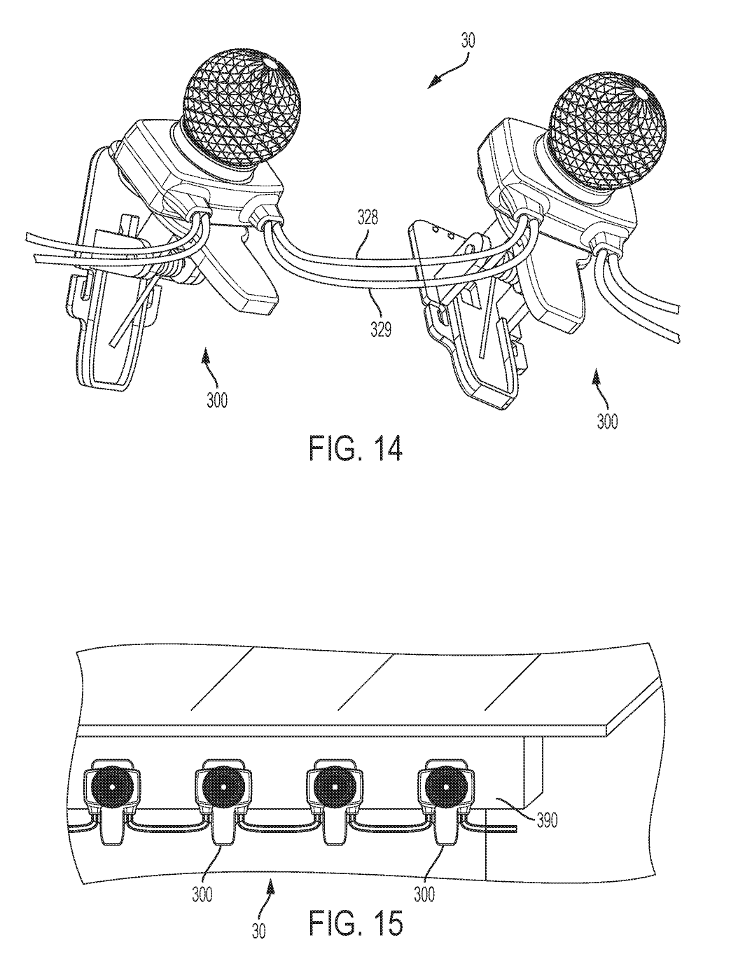

FIG. 14 depicts a lighting system 30 having clip lights 300 located in varying states. FIG. 14 depicts the clip light 300 being connected by wires 328, 329. FIG. 15 shows the lighting system 30 being mounted to a structure 390, for example, a fascia board on a house.

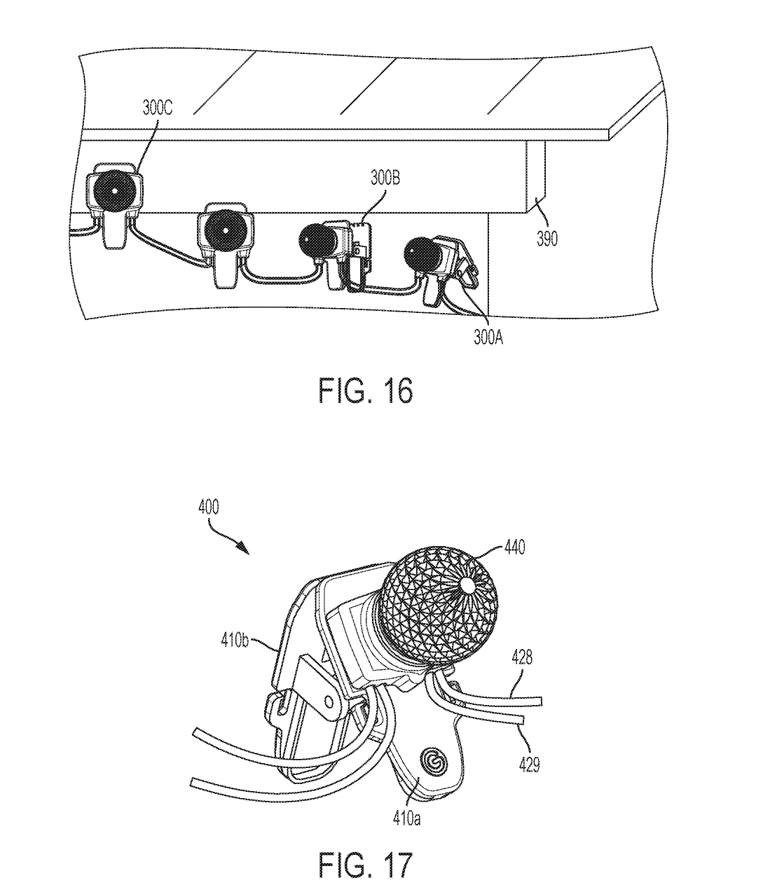

FIG. 16 shows the varying states of the clip light. Clip light 300A shows the clip light in the relaxed, closed state. Clip light 300B is in the more expanded, opened state. Clip light 300C is shown mounted to the structure 390. As shown, the clip light 300 can illuminate outwardly away from the structure to which it is attached. The clip lights can be configured to be oriented directly away from the structure 390 or at an angle to thus project light at various orientations.

Similar to prior embodiments, a plurality of the clip lights 300 can be connected in a string and operated by a control system. The illumination of the lights can be controlled using a controller that is electrically coupled to the lighting system, using structures and functions similar to those disclosed with reference to the first embodiment.

### Fourth Embodiment

FIGS. 17-21 depict a fourth embodiment of a clip light 400 according to the present invention. FIG. 17 shows a perspective view of clip light 400. Clip light 400 can have first and second clamp members 410a, 410b that are connected together in the form of a hinge, and operate in a similar manner as previous embodiments. Wires 428, 429 can proceed in and out of the clip light 400 to supply power and electrical connection. Lens 440, such as a kaleidoscope lens, can illuminate the light from the clip light 400.

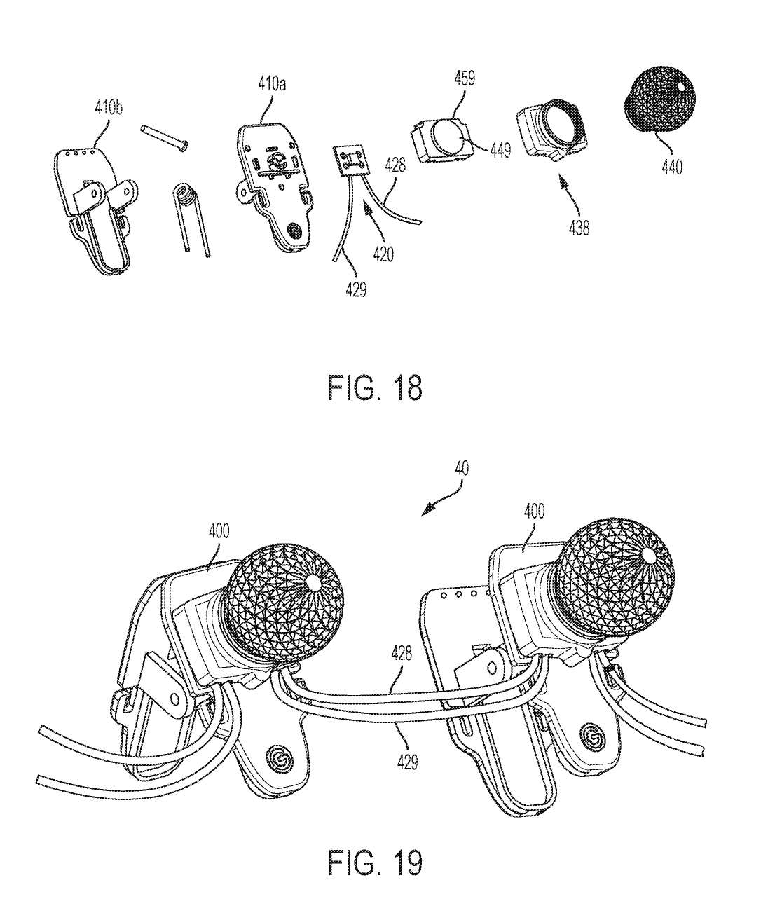

As shown in FIG. 18, an intermediate light unit cover 459 can be directly mounted onto the exterior surface of the first clamp member 410a. In this embodiment, the light unit 420 can be disposed inside the intermediate light unit cover 459 and an upper light unit cover 438 can house the intermediate light unit cover and the light unit 420. The upper light unit cover 459 can be mounted directly onto the exterior surface of the first clamp member 410a. Intermediate cover 459 can include an intermediate member 449, which can allow light from the light unit 420 to transmit through. As shown in FIG. 18, the intermediate member 449 can be in the shape of a circle, however, other shapes are possible. The intermediate member 449 can be made of plastic, glass, or other durable but transparent/translucent material. According to embodiments, based on the translucent nature of the intermediate member 449 in some embodiments, light emitted from the light unit 420 can be made more uniformly distributed by passing through the intermediate member 449. Other structural aspects of the clip light 410 can be similar to those described in the third embodiment.

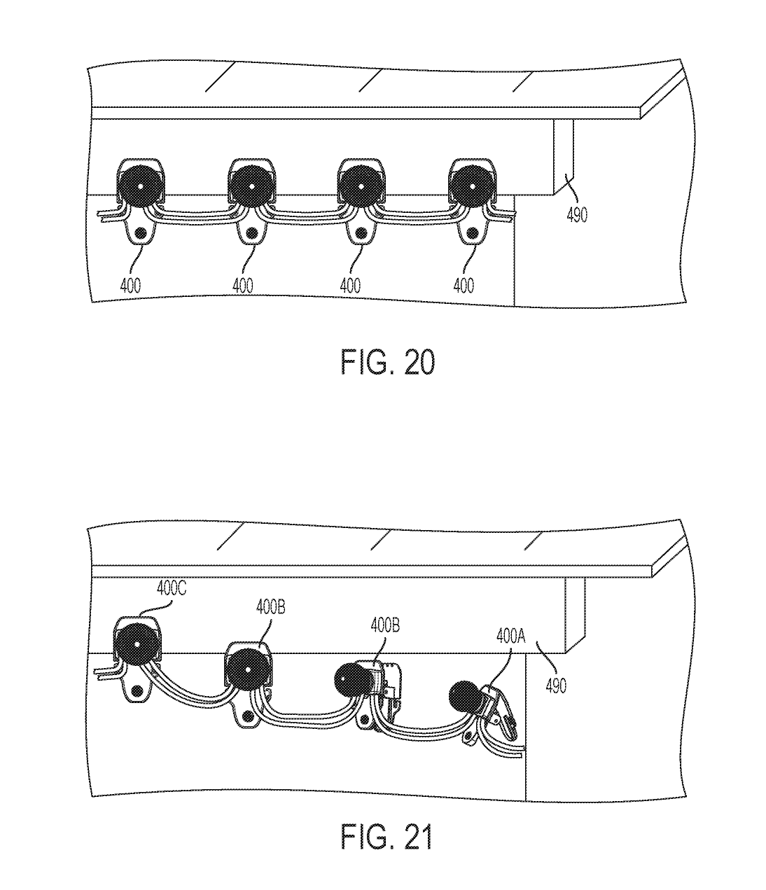

FIG. 19 shows a lighting system 40 including a chain of clip lights 400 connected by wires 428, 429 with one of the clip lights in a closed, relaxed state and one of the clip lights in an open, expanded state. FIG. 20 shows the chain of clip lights 400 mounted to a structure 490, such as a fascia board. FIG. 21 shows a progression of the state of the clip lights with clip light 400A being in a relaxed, closed state, clip lights 400B being in a more open, more expanded state, and clip light 400C being in a mounted state. Other features and aspects of clip light 400 can be the same or substantially the same as clip light 300 from the third embodiment.

### Fifth Embodiment

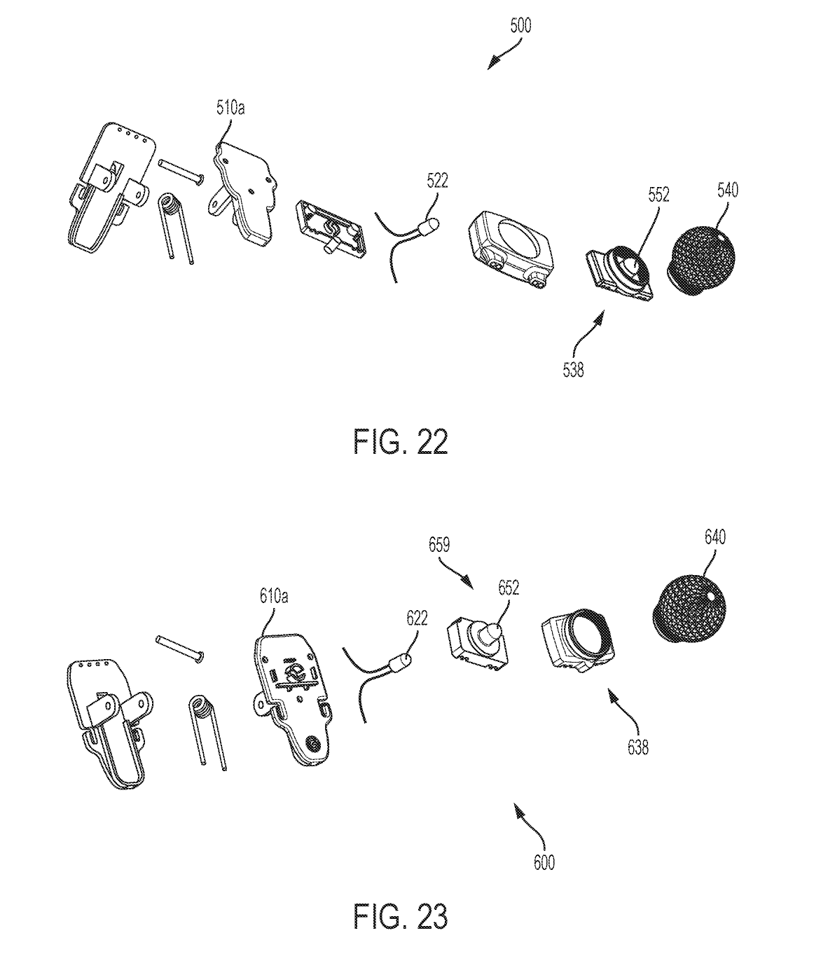

FIG. 22 shows an embodiment of a clip light 500 that is similar to the third embodiment except for the differences described herein. In FIG. 22, the light unit 520 can include a capsule-shaped LED 522 rather than a surface mounted LED. The capsule-shaped LED 522 can protrude orthogonal to and upwards from the surface of the clamp member 510a. The capsule-shaped LED 522 can extend into a receptacle 552 provided in the upper light unit cover 538 for receiving the capsule-shaped LED 522. The receptacle 552 can be transparent or translucent, and allow for distribution of light throughout the lens 540, which can comprise a beam-splitting kaleidoscope lens. Alternatively, the capsule-shaped LED 522 can shine directly into the lens 540. According to embodiments, the upper light unit cover 538 and receptacle 552 can be made of colorful materials, such as colored plastic, glass, or other materials, that changes the light emitted from light unit 520.

### Sixth Embodiment

FIG. 23 shows a sixth embodiment of a clip light 600 that is similar to the clip light of the fourth embodiment, except as described hereinafter. Here, the clip light 600 can include a capsule-shaped LED 622 that is configured to stand upright inside the light unit covers. An intermediate light unit cover 659 can include a receptacle 652 that is configured to receive the capsule-shaped LED 622. This can allow for the light to be distributed to the lens 640, which can comprise a beam splitting kaleidoscope lens. The intermediate light unit cover 659 can be housed inside the upper light unit cover 638. The intermediate unit cover 659 can be directly mounted to the first clamp member 610a underneath the upper light unit cover 638. According to embodiments, the upper light unit cover 638 and receptacle 652 can be made of colorful materials, such as colored plastic, glass, or other materials, that changes the light emitted from light unit 520.

### Seventh Embodiment

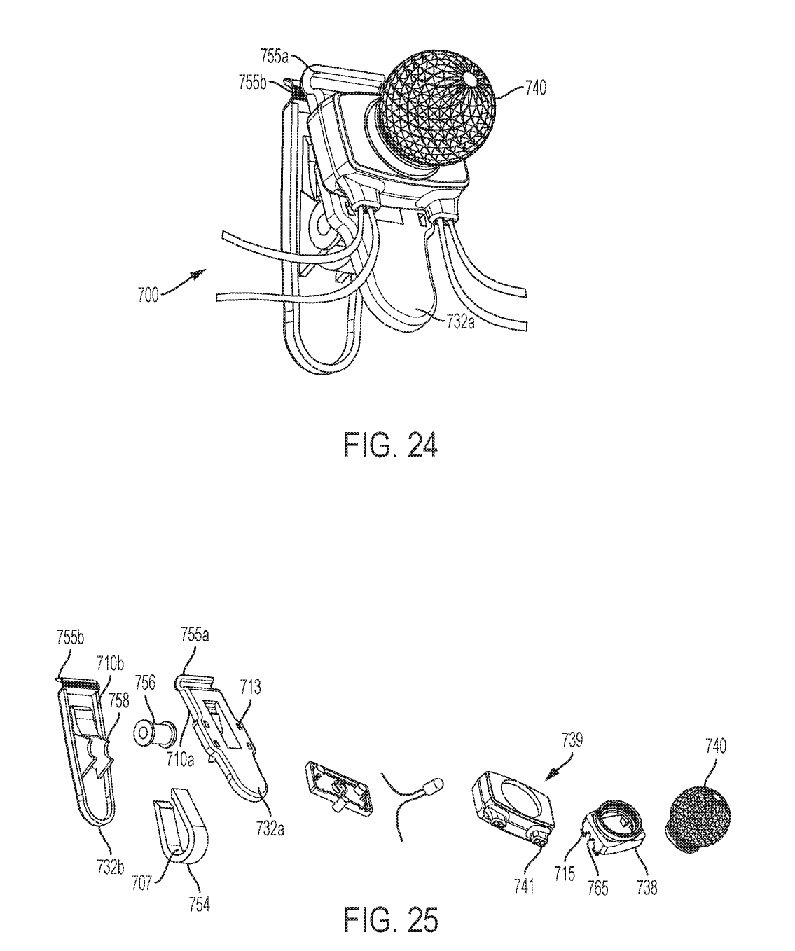

FIGS. 24-26 show a perspective view of a clip light 700 according to a seventh embodiment of the invention. As can be seen from the exploded view in FIG. 25, some components are similar to the fifth embodiment. Here, the first and second clamp members 710a, 710b can be shaped to interface with a dowel pin 756. That is, the first and second clamp members 710a, 710b can each include raised ridges 758 (hidden from view for clamp member 710a) that outline a partially circular cross-section. The raised ridges can interface with and allow for pivoting of the clamp members 710a, 710b about the dowel pin 756. A resilient spring clip 754 can bias the two clamp members 710a, 710b towards each other. The spring clip 754 can receive the dowel pin 756 in a central space 707 of the spring clip 754. While the dowel pin 756 is in the central space of the spring clip 754, opposing end portions of the dowel pin can engage within pockets (hidden for clamp member 710a) formed under the raised ridges 758 to bias the ends 755a, 755b of the clamp members 710a, 710b towards one another. At the same time, the exterior surface of the spring clip 754 can abut against the interior surface of the first and second clamp members 710a, 710b and can be configured to push against the interior surface of the first and second clamp members 710a, 710b. Pressure applied to the bottom portions 732a, 732b of the first and second clamp members 710a, 710b (e.g., by a user's fingers) can cause the spring clip 754 to resiliently move into an open state. In this configuration, pressure applied towards end portions 732a, 732b opens up the spring clip 754, and the configuration of the spring clip 754 will bias the first and second clamp members 710a, 710b back to its resting state. The ends 755a, 755b of the first and second clamp members 710a, 710b can each define outwardly curved surfaces, as shown in FIG. 24. Ridges or other friction-enhancing surfaces can be provided on the interior-facing surfaces of these ends 755a, 755b.

Clamp members 710a, 710b can be made of plastic, metal, composite, wood or any other durable material. The spring clip 754 can be made of plastic (including hard plastic), rubber, metal, composite or any other resilient yet flexible material that allows for the opening of the spring clip 754. The dowel pin 756 can be made of plastic, metal, composite, wood or any other resilient material that is configured to withstand and distribute pressure.

Light unit cover 738 can include snaps 715 that are configured to fit into notches 713 on the exterior surface of first clamp member 710b. The snaps 715 can snap into or otherwise engage with the notches 713 for a solid, durable fit. As shown in FIG. 25, the kaleidoscope lens 740 can attach to the light unit cover 738 using mating threads.

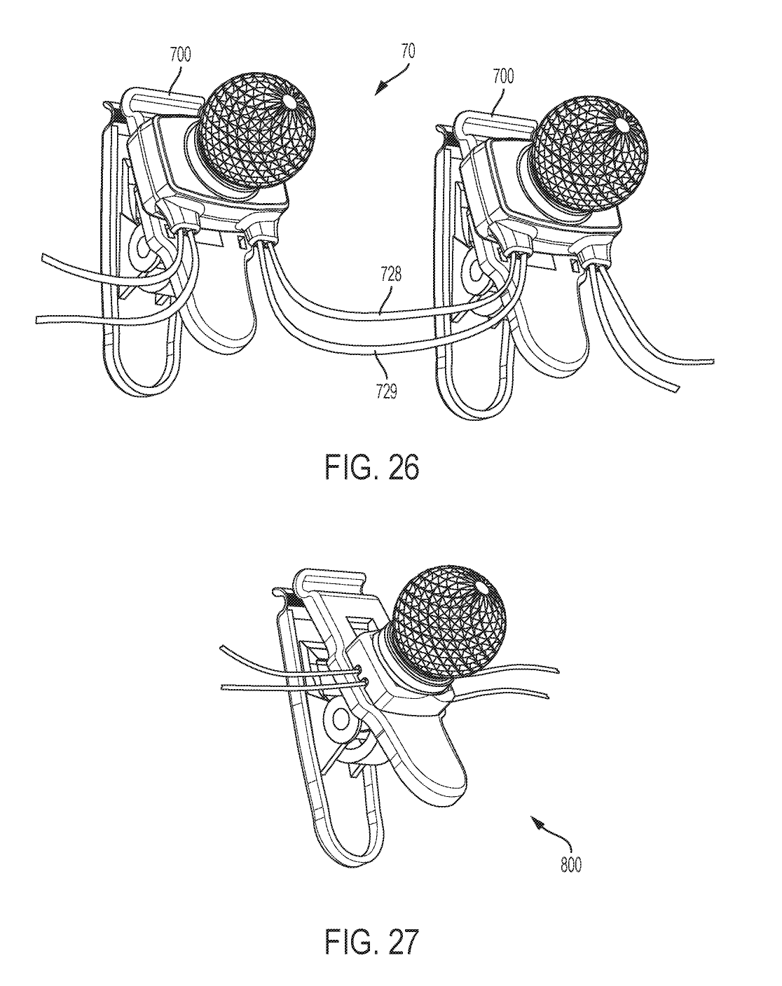

Also shown in FIG. 25 is that the upper light unit cover 738 can outline grooves 765 on a side of the cover to allow for wires to extend therethrough. The exterior housing 739 can still have the wire adapters 741 outline holes at the bottom to facilitate the wires entering and exiting the clip from the bottom of the clip. Thus, as shown in FIG. 26, a lighting system 70 can include a string of clip lights 700 can be connected by wires 728, 729. The operation and control of the clip lights 700, and related structures, can be similar to the description provided for the first embodiment.

### Eighth Embodiment

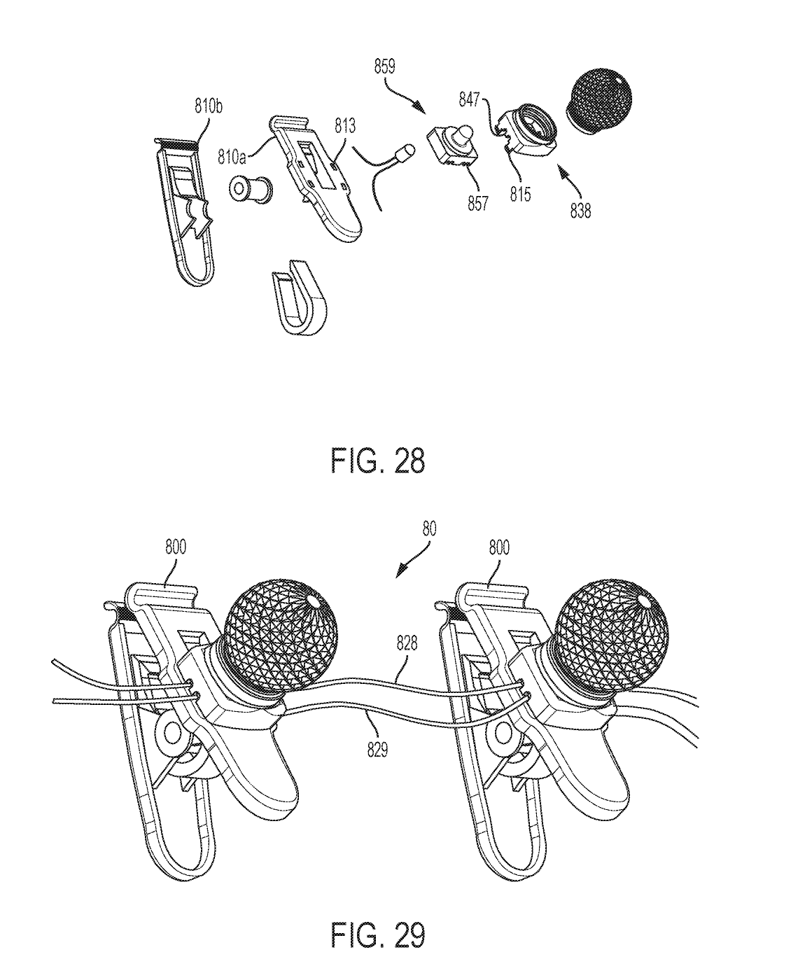

FIGS. 27-31 show a perspective view of a clip light 800 according to an embodiment that is similar to the clip light 700 of the seventh embodiment, except as described herein below. As shown in FIG. 28, the light unit cover 838 can be directly connected to the first clamp member 810a, as described with some earlier embodiments. The intermediate light unit cover 859 can define grooves 857 for wires to extend through the bottom of the cover. The light unit cover 838 can define grooves 847 located in registry with the grooves 857 of the first upper light unit cover 859. In this manner, wires 828, 829 exiting and entering the light unit covers can do so at the side of the clip light. Light unit cover 838 can include snaps 815 that are configured to fit into notches 813 on the exterior surface of first clamp member 810a. The snaps 815 can snap into or otherwise interface with the notches 813 for a solid, durable fit.

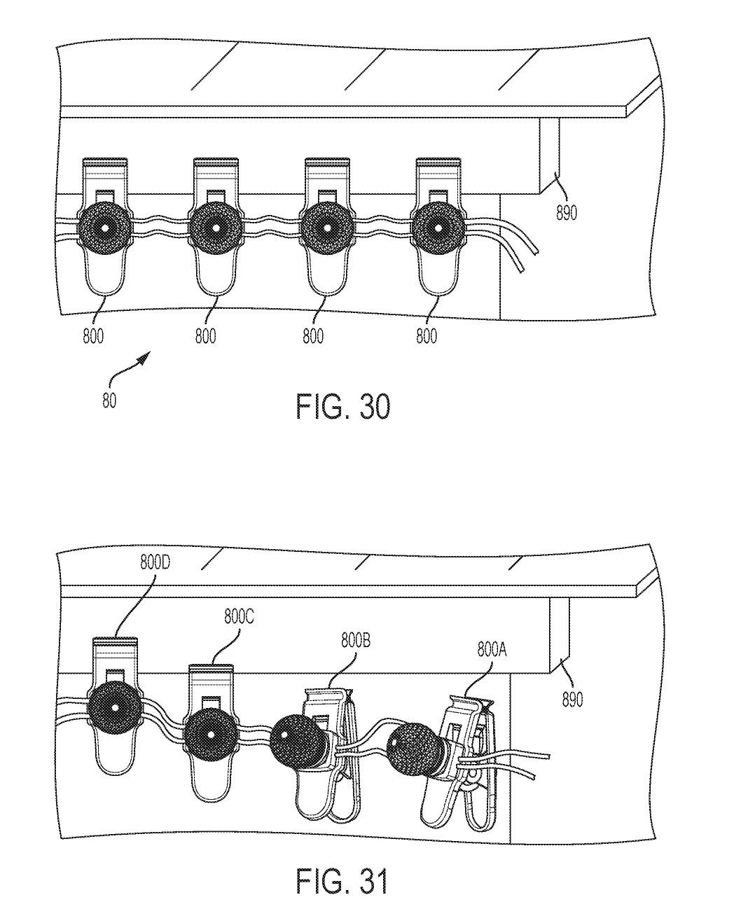

FIG. 29 depicts a lighting system 80 comprising two clip lights 800 connected by wires 828, 829, similar to previous embodiments. FIG. 30 shows a string of clip lights mounted to a structure 890, according to the eighth embodiment of the invention. FIG. 31 shows various stages of the clip lights in mounting to the structure, with clip lights 800A and 800B being shown in a closed, relaxed state, clip light 800C being shown in a more open, expanded state, and clip light 800D being shown in a mounted state.

### Ninth Embodiment

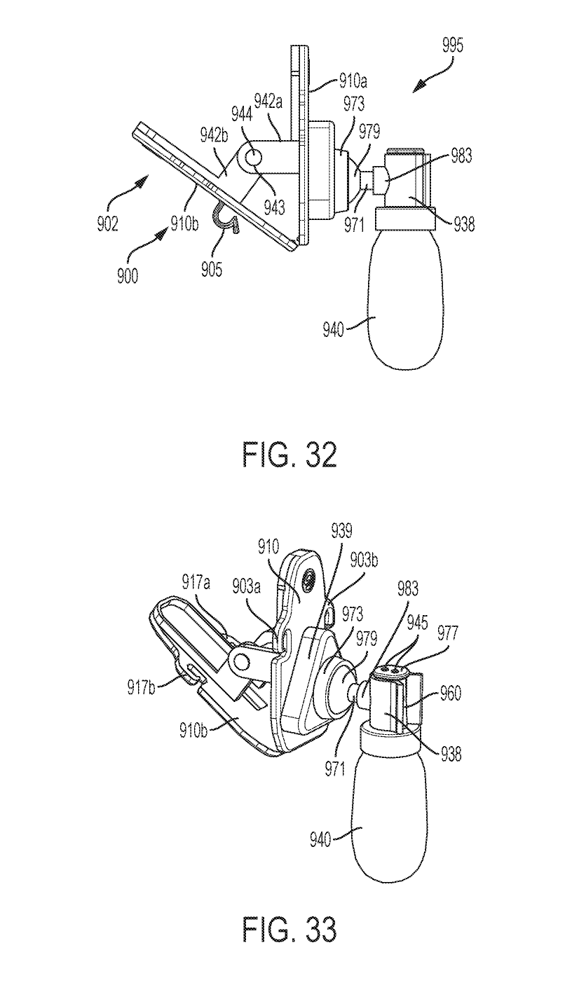

FIGS. 32-37 depict a clip light 900 according to a ninth embodiment of the invention. The clip light 900 can include an articulating joint that allows the orientation of the light unit to be adjusted with respect to the clip, for example, to provide flexibility in placement of the clip. FIG. 32 shows a side view of the clip light 900. As shown, the clip light 900 can include a clip 902 that can include clamp members 910a, 910b having extension arms 942a, 942b, respectively. Each extension arm 942a, 942b can define a hole 943 for receipt of a pin 944. The pin 944 can form a hinge between the clamp members 910a, 910b, similar to some of the previously-described embodiments. The clamp members 910a, 910b can be biased toward each other by means of a spring (not shown) or other elastic member disposed in between the two members (see, e.g., FIGS. 22-23) or in another way.

Clamp members 910a, 910b can be made of plastic, metal, composite, wood, or any other durable material. The arms 942a, 942b can be made of plastic (including hard plastic), rubber, metal, composite, wood, or any other durable material. The pin 944 can be made of hard plastic, metal, composite, or other material that is configured to withstand and distribute pressure.

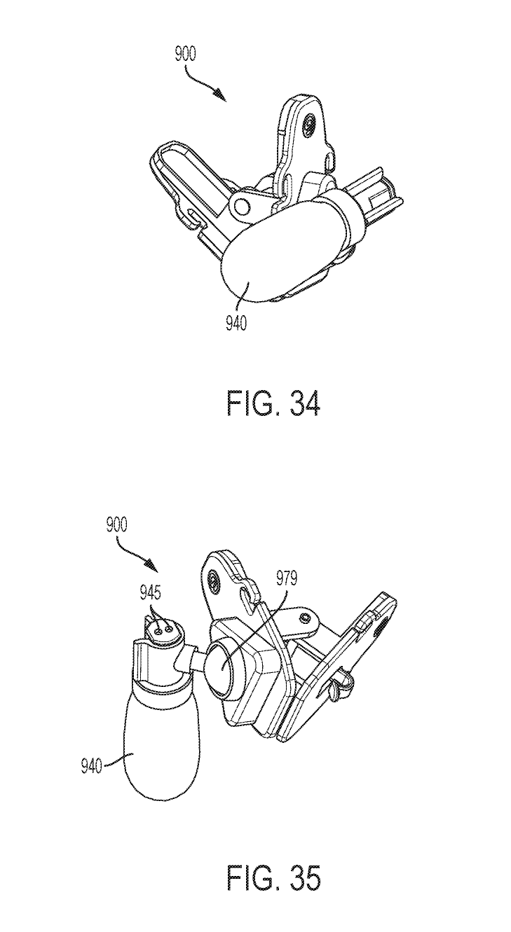

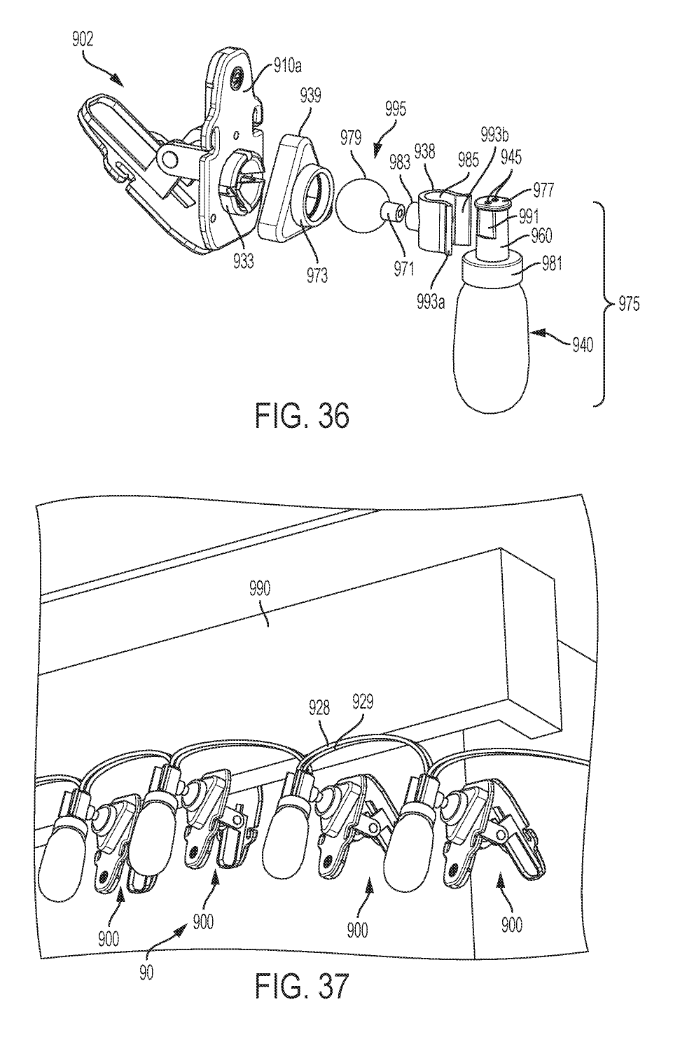

As shown in FIG. 32, the clip light 900 can include an articulating joint 995 between the clip 902 and the lens 940. The joint 995 can allow the lens 940 to rotate about multiple axes with respect to the clip 902, as depicted in FIGS. 34 and 35. With reference to FIG. 36, the joint 995 can include a ball head 979 that mates with a socket defined by a receiving cavity 933 in the first clamp member 910a, and a cover 939 that attaches to the first clamp member 910a over the cavity 933. The cover 939 can attach to the first clamp member 910a using mating pins and cavities, as shown, or alternatively, using other known techniques including adhesives and/or fasteners. The cavity 933 can include reliefs that allow the cavity 933 to flex under the application of pressure, for example, from the ball head 979.

A connecting portion 971, for example, in the shape of a cylindrical boss, can extend from the ball head 979. The connecting portion 971 can extend through a flange 973 on the cover 939. The flange 973 can engage the connecting portion 971 to limit the range of motion of the ball head 979 within the socket.

The clip light 900 can include a snap collar 938 having a flange 983 that engages with the connecting portion 971 of the ball head 979, for example, in a manner that allows the snap collar 938 to pivot with respect to the ball head 979 about the connecting portion 971/flange 983. The snap collar 938 can define a cavity 985 that is configured to resiliently engage and secure a portion of the light unit 975. The cavity can be defined as a cylindrical channel with an open lateral region, as depicted in FIG. 36, however, other shapes are possible. The components of the rotatable interface member 995 can be made of hard plastic, metal, composite, or other durable materials, and/or combinations thereof. Hooks 917a, 917b (see FIG. 32) can be disposed on the edge of clamp member 910b and hooks 903a, 903b can be disposed on the edge of clamp member 910a. Hook 905 can be disposed in the center of clamp member 910b and can protrude away from the exterior surface of the clamp member 910b. The hook 905 and hooks 903a, 903b and 917a, 917b can be used to manage the placement of the wires.

Still referring to FIG. 36, a lens base 960 can be secured to the translucent or transparent lens 940, for example, by a flange 981. According to embodiments, the lens base 960 can take the shape of a cylinder, however, other shapes are possible. The lens base 960 can also include at least one planar surface 991. The lens base 960 can snap into and resiliently engage within the cavity 985 of the snap collar 938 to releasably connect the lens 940 to the clip 902. According to embodiments, the light unit 975 can be configured to rotate along the axis of the lens base 960 with respect to the snap collar 938. The snap collar 938 can wings 993a, 993b on either side of the groove to facilitate insertion of the lens base 960 into the cavity 985. The snap collar 938 in some embodiments can be made of a material that has a coefficient of flexibility to allow for the snap collar 938 and/or wings 993a, 993b to flex to receive the lens base 960 of the light unit 975. According to the embodiments shown, the cover 939 is shaped as a triangle, however, other shapes are possible.

According to embodiments, the snap flange 938 can be configured to receive the lens base 960 in the cavity 985 so that very little or no movement of the light unit 975 relative to the snap collar 938 takes place. As described previously, the lens base 960 can include at least one planar surface 991. According to embodiments where the lens base 960 has two of the planar surfaces 991 diametrically opposed, the planar surfaces 991 can be aligned with the wings 993a, 993b to facilitate insertion of the lens base 960 into the cavity 985 by virtue of the width of the lens base 960 (at the planar surfaces) being smaller than the width of the lateral entrance to the cavity 985. The light unit 975 can then be twisted to prevent the lens base 960 from unintentionally exiting the cavity 985. In some embodiments, the lens base 960 can include two planar surfaces 991. In some embodiments, the lamp holder does not have any planar surfaces at all and has a shape of a cylinder. The width of the lens base 960 can be bigger than the lateral entrance to the cavity 985 so as to prevent the lens base 960 from unintentionally exiting the cavity 985. As shown in FIG. 39, the lens base 960 can have a base surface 977 that defines one or more holes 945 for wires 928, 929 to proceed through. The wires 928, 929 can connect with one or more lighting units (hidden from view), such as LEDs, located within the interior of lens 940.

The clip light 900 can allow for two or more degrees of movement of the light unit 975 relative to the clip 902, which can remain stationary while the light unit 975 moves. According to embodiments, the light unit 975 can rotate in a substantially spherical range of movement due to movement of the ball head 979 with the socket defined on the clip 902. According to embodiments, the light unit 975 can also rotate about the axis of shaft portion 971. FIG. 33 shows the clip light 900 with the shaft portion 971 oriented substantially perpendicularly to the first clamp member 910a. FIG. 33 also shows the lens base 960 oriented substantially parallel to the first clamp member 910a. Accordingly, the lens 940 extends straight out and downward from the first clamp member 910a. FIG. 34 shows the lens 940 after being rotated upward about the axis of the shaft portion 971 by about 90 degrees. FIG. 35 depicts the clip light 900 after the lens 940 has been further rotated upwards about the ball head 979.

FIG. 37 shows a lighting system 90 including a string of clip lights 900 in various stages of attachment to a structure 990. Wires 928, 929 can connect the clip lights 900. The lens 940 on each clip light 900 can be oriented in different directions, which can be convenient for users to provide flexibility in mounting the clips 902 and/or in orienting the lamp bodies 940 in various directions. The illumination of the lights can be controlled using a controller that is electrically coupled to the lighting system, using structures and functions similar to those disclosed with reference to the first embodiment.

### Tenth Embodiment

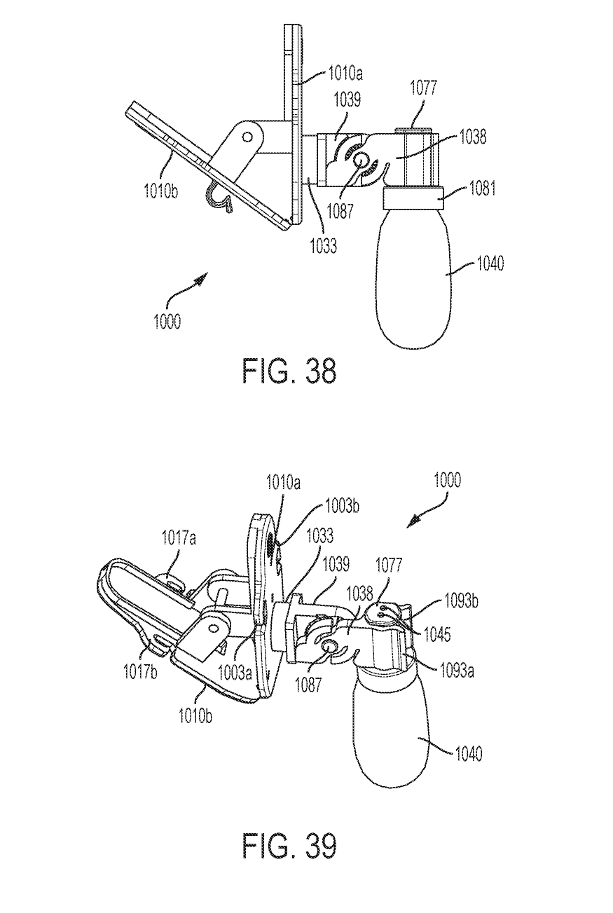

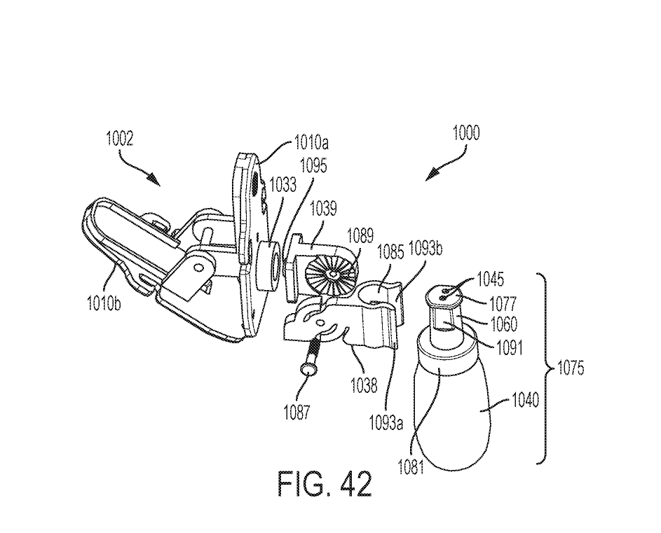

FIGS. 38-43 show an embodiment of a clip light 1000 similar to the ninth embodiment shown in FIGS. 32-37, except that the clip light of FIGS. 38-43 includes a rotatable joint 1039 instead of a ball head. Referring to the exploded view of FIG. 42, clip light 1000 can include a rotatable interface member 1039 having a shaft 1095 (e.g., a cylindrical shaft) on a first end and a toothed engaging portion 1089 on an opposing end. The clip light 1000 can include a snap collar 1038 defining a cavity 1085 with wings 1093a, 1093b, similar to the ninth embodiment. The snap collar 1038 can further include its own toothed engaging portion (hidden from view) that is configured to mate with and engage the toothed engaging portion 1089 of the rotatable interface member 1039 at multiple angular orientations of the snap collar 1038 and shaft 1095. The light unit connector 1038 can define a cavity 1085 that is configured to engage with a portion of the light unit 1075, as in previous embodiments.

As with the previous embodiment, the light unit 1075 can include a lens base 1060 at the proximal end having at least one planar surface 1091. The lens base 1060 can releasably snap into the cavity 1085 of the snap collar 1038 as with the prior embodiment. The lens 1040 can be joined to the lens base 1060 using, for example, flange 1081, however, other configurations are possible.

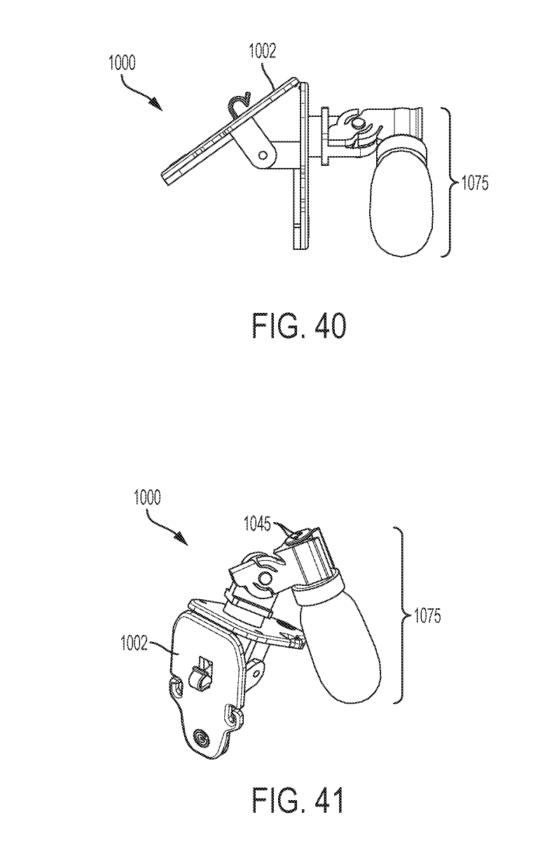

The rotatable interface member 1039 can be connected to the first clamp member 1010a via a receiving portion 1033 formed on the first clamp member 1010a. The receiving portion can define a bore that receives and engages the shaft 1095 of the interface member 1039. In such a configuration, the interface member 1039 can pivot about shaft 1095 with respect to the clip 1002, providing adjustability for the position of lens 1040 with respect to the clip 1002. This adjustability can be seen, for example, in FIGS. 40-41 as the lens 1040 is oriented in a different direction from FIGS. 38-39.

According to embodiments, the light unit 1075 can rotate about multiple axes with respect to the clip 1002. For example, the light unit 1075 can rotate about shaft 1095 with respect to the clip 1002. The interface member 1039 can provide additional degrees of rotation. As mentioned previously, and with reference to FIG. 42, the interface member 1039 can have a toothed engaging portion 1089 that can engage with the connector body 1038. In some embodiments, the engaging portion 1089 can engage with the connector body 1038 through a corresponding toothed engaging portion (hidden) that is complementary in shape to the engaging portion 1089. Each engaging portion can be a substantially circular fan-shape interface comprising a plurality of radially-extending ridges and valleys on the surface. One of the engaging portions can be positioned in mating engagement with the other engaging portion and tightened by either a threaded fastener 1087, a spring-biased pin joint, or other structure known in the art. The ridges and valleys when engaged can prevent rotation of the two interfaces with respect to one another, thereby substantially fixing the angular position of the connector body 1038 with respect to the clip 1002. According to embodiments, the engaging portion 1089 and/or the toothed engaging portion of the connector body 1038 can be formed of a material having sufficient elasticity to allow a predetermined level of force applied to connector body 1038 to move the teeth past one another, to provide adjustment of the angular orientation of the light unit 1075. Each of the grooves around the engaging portion 1089 can allow for the connector body 1038 to lock into the desired angular orientation. Having many of the grooves allows for slight rotations for precise adjustment of the position of the light unit 1075. While the engaging portions in some embodiments can have a circular fan-shaped surface, any shaped surface that provides rotational resistance between the two pieces is contemplated within the broad inventive principles disclosed herein, including, for example, surfaces that are roughened to provide increased frictional engagement.

As shown in FIG. 42, the lens base 1060 can have a base surface 1077 that defines one or more holes 1045 for wires 1028, 1029 to proceed through. The wires 1028, 1029 can connect to one or more light units (not shown), such as LEDs, located within the lens 1040.

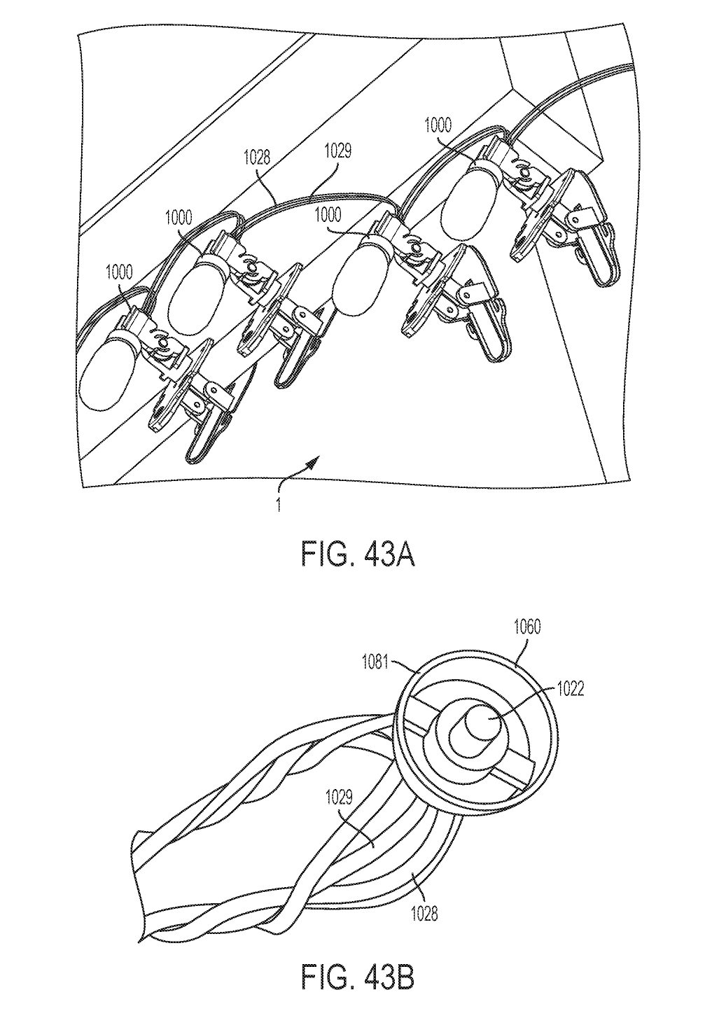

FIG. 43A shows a lighting system 1 including a string of clip lights 1000 attached to a structure, such as a home, for example, using wires 1028, 1029. The clip lights can be operated using similar structures and functions as described in connection with prior embodiments. The electronics and light components can be disposed inside the base 1060 of the light unit 1075. FIGS. 40 and 41 depict the clip light 1000 with the light unit 1075 oriented in various different orientations with respect to the clip 102.

FIG. 43B shows a perspective view of the light unit 1075 with the lens 1040 removed from the lens base 1060. As shown, the light 1022 can be an LED, such as an encapsulated LED, housed within the lens base 1060. Any associated electronics (such as a circuit board) can also be located in the lens base 1060. Wires 1028, 1029 can extend into the base 1060, for example, through holes 1045. The illumination of the lights can be controlled using a controller that is electrically coupled to the lighting system, using structures and functions similar to those disclosed with reference to the first embodiment.

### Eleventh Embodiment

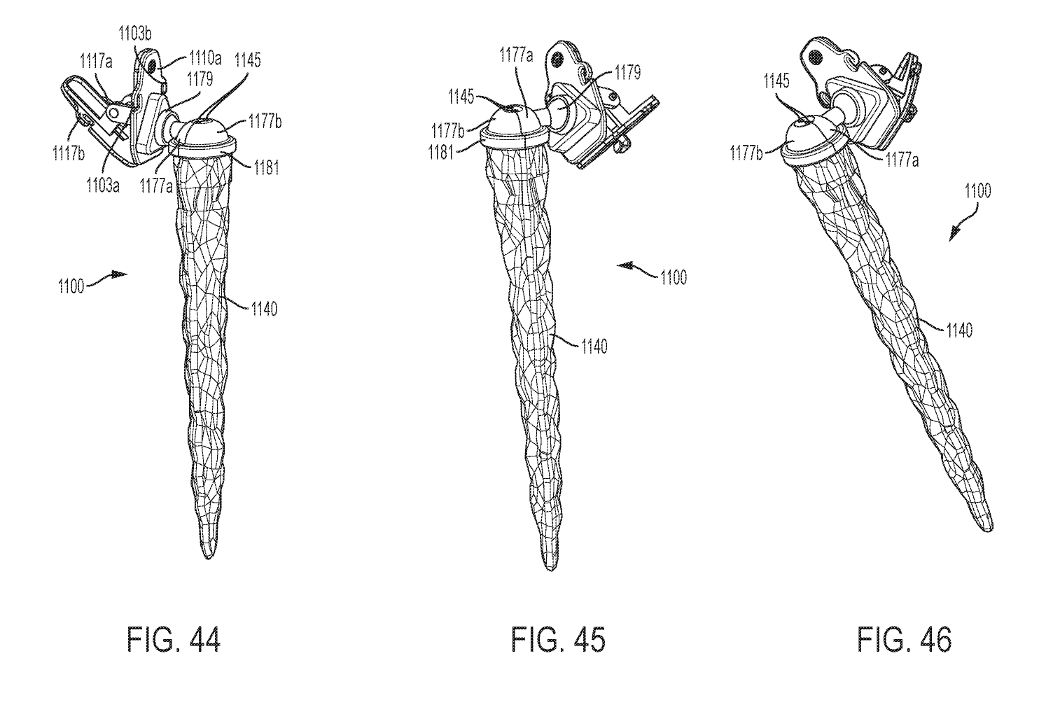

FIGS. 44-49 show a clip light 1100 having a similar configuration to the ninth embodiment clip light with a difference being that the releasably engageable snap collar 938 and lens base 960 are replaced with a fixed lamp cover 1177a, 1177b. Additionally, the lens 940 of the ninth embodiment is replaced with a lens 1140, which, as shown, can be designed to resemble an icicle.

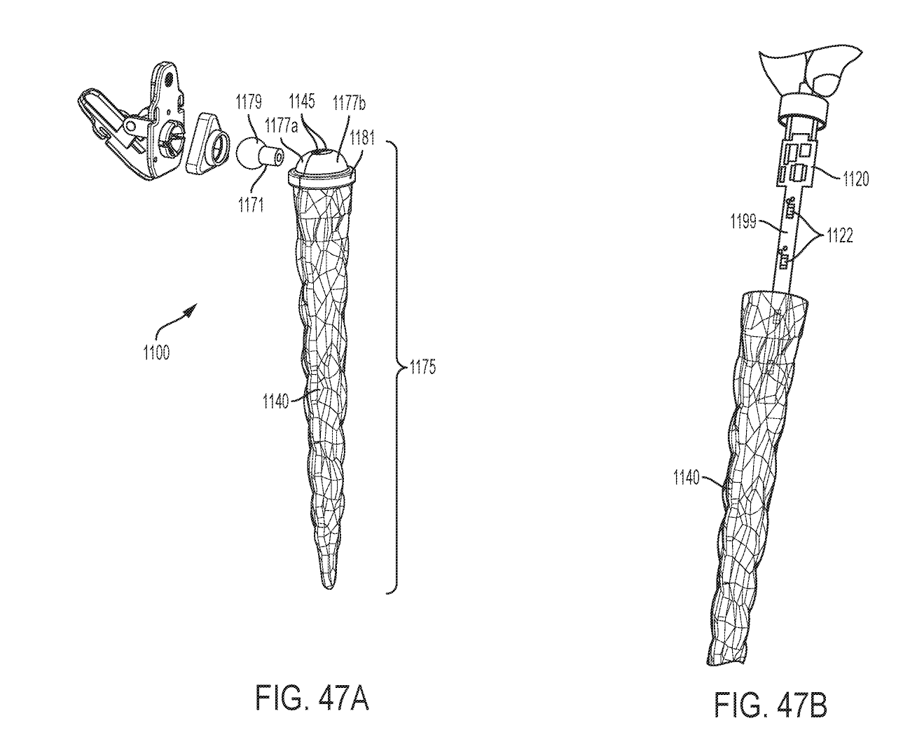

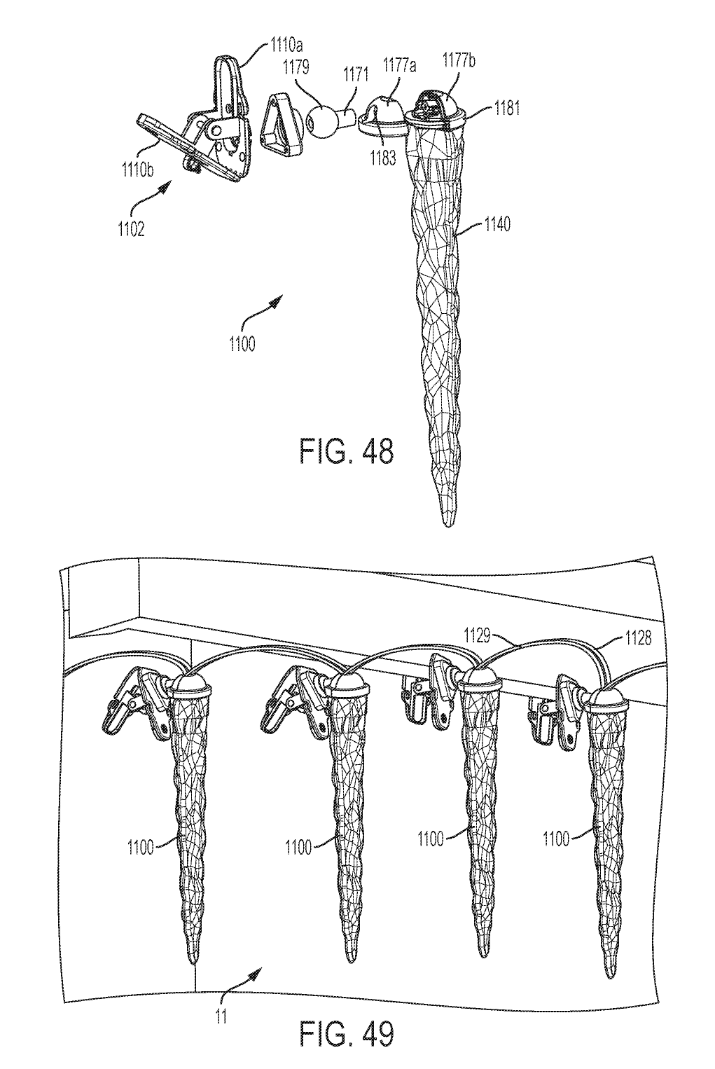

Similar to the ninth embodiment, and as shown in FIGS. 47A and 48, the clip light 1100 can include a rotatable ball head 1179 attached to the first clamp member 1110a. As with the ninth embodiment, and with reference to FIG. 48, the rotatable ball head 1179 can include a shaft 1171 projecting therefrom, for example, a cylindrical shaft. The lamp cover 1177a, 1177b can be attached to the shaft 1171, as will be described in more detail below.

FIG. 47B shows an exploded view of the lens 1140 and internal components. For example, an elongated circuit board 1199 can be connected to the wires 1128, 1129 (see FIG. 49). The circuit board 1199 can extend within the lens 1140. Internal circuitry 1120 and light units, such as LEDs 1122, can be provided on the circuit board 1199. The circuitry 1120 can control the operation of lights 1122. As shown in FIG. 46, the fixed lens cover 1177a, 1177b can define one or more holes 1145 for passage of the wires 1128, 1129, as shown in FIG. 49.

Referring to FIG. 48, the fixed lamp cover 1177a, 1177b can comprise a dome-shaped cap that attaches to the top of the lens 1140, for example, by having flange 1181 engage with a lip formed at the top of the lens 1140. However, one of ordinary skill in the art will appreciate based on this disclosure that other structures can be used to connect the fixed lamp cover 1177a, 1177b and the lens 1140. The fixed lamp cover 1177a, 1177b can comprise a multi-part cover having first and second portions 1177a, 1177b joined laterally to form the cover, however, other configurations are possible. In the embodiment shown, the connector body portion 1177a can define an interface in the form of a bore 1183 that receives and engages the shaft 1171, thereby joining the light unit 1175 to the ball head 1179 and the associated clip 1102. According to embodiments, the fixed lamp cover 1177a, 1177b can rotate about the axis of shaft 1171. Additionally, the ball head 1179 can rotate about multiple axes with respect to the clip 1102. This configuration allows the user to move and position the lamp 1140 in various positions with respect to the clip 1102. For example, FIGS. 45 and 46 show clip lights 1100 with the lens 1140 oriented in different directions from FIG. 44. As shown in FIGS. 44-49, the lens 1140 can comprise a transparent or translucent, cone-shaped member having multiple facets that resemble the shape of an icicle.

FIG. 49 shows a lighting system 11 comprising a string of clip lights 1100 connected, for example, to a home. The clip lights 1100 can be connected together, for example, using wires 1128, 1129. The clip lights can be operated using similar structures and functions as described in connection with prior embodiments.

### Twelfth Embodiment

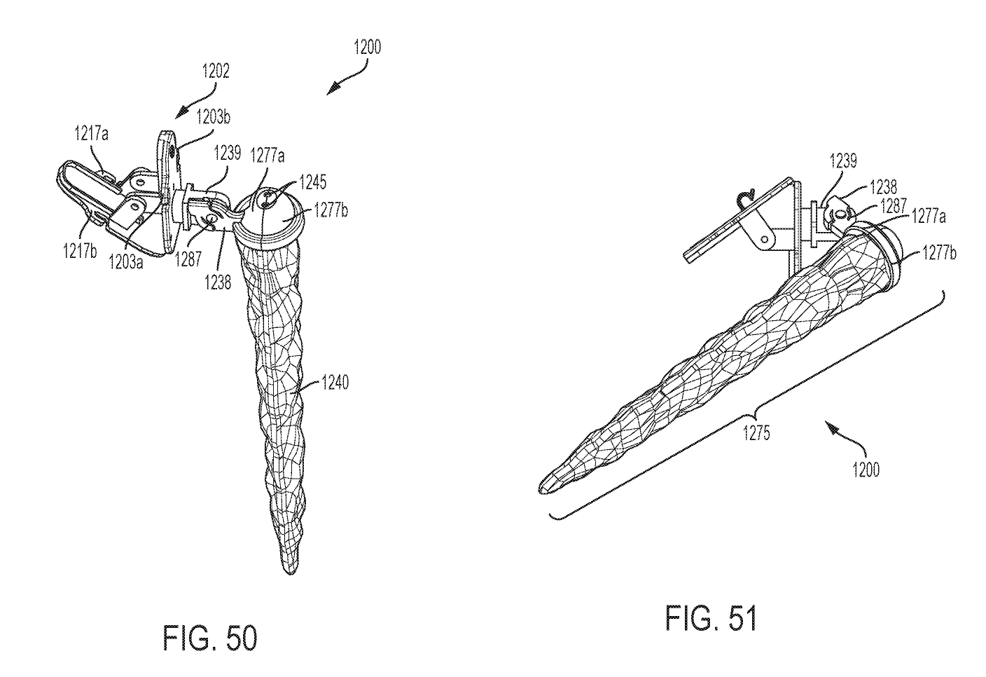

FIGS. 50-54 depict another embodiment of the present invention. FIG. 50 shows a perspective view of a clip light 1200 similar to the clip light 1000 of FIG. 38 except that the releasably engageable snap collar 938 and lens base 960 are replaced with a fixed lamp cover 1277a, 1277b, similar to the eleventh embodiment. Additionally, the lens 940 of the ninth embodiment is replaced with a lens 1240 similar to the eleventh embodiment, which, as shown, can be designed to resemble an icicle.

As shown in FIG. 53, the fixed lamp cover portion 1277a can include a rotatable interface portion 1238 having a toothed engaging portion (hidden) that is complementary in shape to the engaging portion 1289 of the rotatable interface portion 1239. Similar to the description of the tenth embodiment, one of the engaging portions can be positioned in mating engagement with the other engaging portion and tightened by either a threaded fastener 1287, a spring-biased pin joint, or other structure known in the art. The ridges and valleys of the rotatable interface portions, when engaged, can prevent rotation of the two interfaces with respect to one another, thereby substantially fixing the angular position of the fixed lamp cover 1277a, 1277b (and attached lens 1240) with respect to the clip 1202.

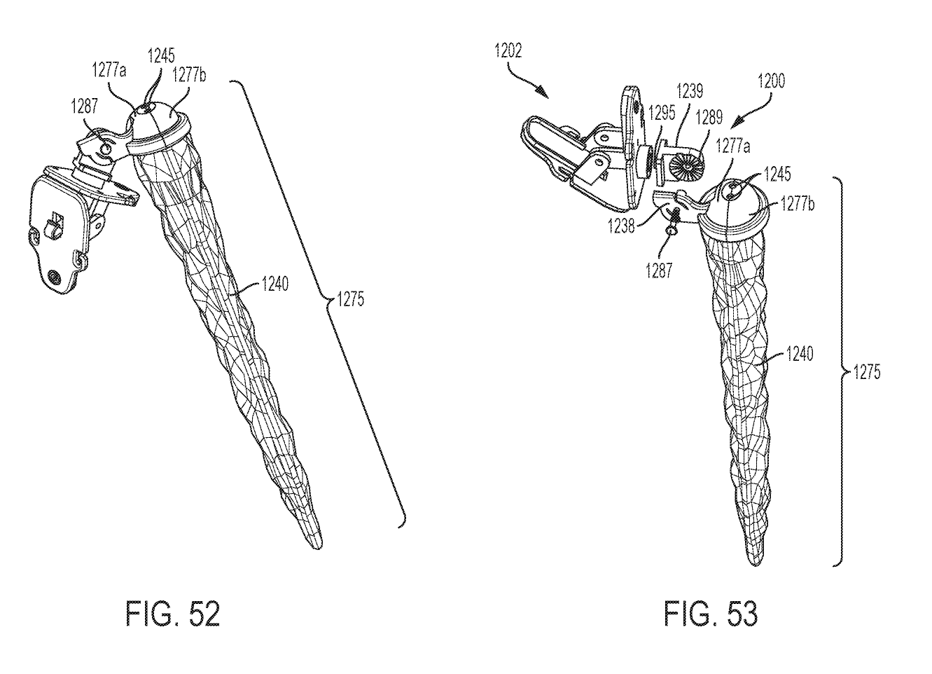

The light unit 1275 can rotate about at least two axes with respect to the clip 1202. For example, the rotatable interface portion 1239 can rotate about the axis of shaft 1295 (see FIG. 53) with respect to clip 1202. Additionally, the light unit 1275 (including lens 1240) can pivot with respect to clip 1202 about the threaded fastener 1287. For example, FIG. 50 shows the rotatable interface portion 1238 oriented straight out from the first clamp member 1210a. FIGS. 51 and 52 show the light unit 1275 after being rotated upward about the axis of the fastener 1287. Thus, FIGS. 51 and 52 show clip lights with the light unit 1275 oriented in a different direction than in FIG. 50.

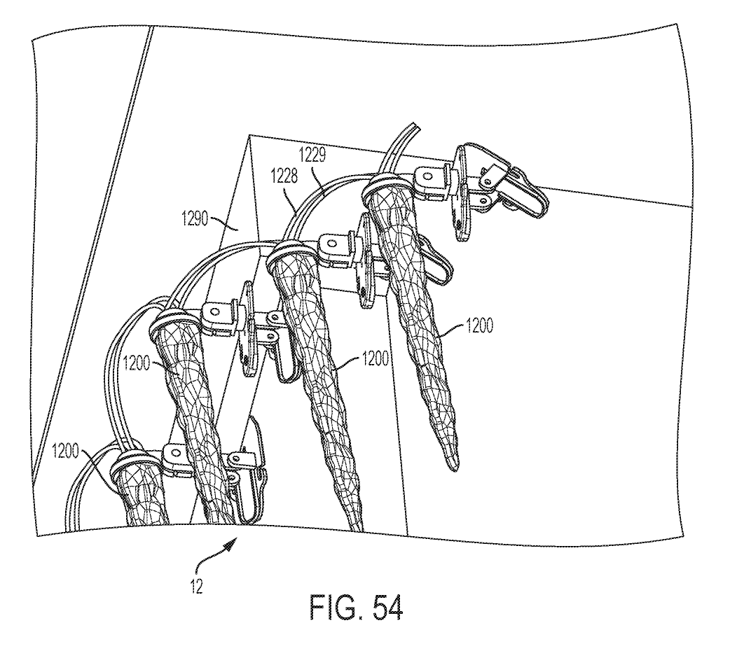

As shown in FIG. 52, the fixed lamp cover 1277a, 1277b can define one or more holes 1245 for wires 1228, 1229 to proceed through, as shown in FIG. 54. The wires 1228, 1229 can connect to one or more lighting units inside lens 1240, for example, in a similar manner to what is shown in FIG. 47B.

FIG. 54 shows a system 12 comprising a string of clip lights 1200 attached to a structure 1290, such as an eave. As described above, one or more light units, such as LEDs, can be housed in each lens 1240 and connected to power and controls via the wires 1228, 1289. The clip lights can be operated using similar structures and functions as described in connection with prior embodiments.

### Thirteenth Embodiment

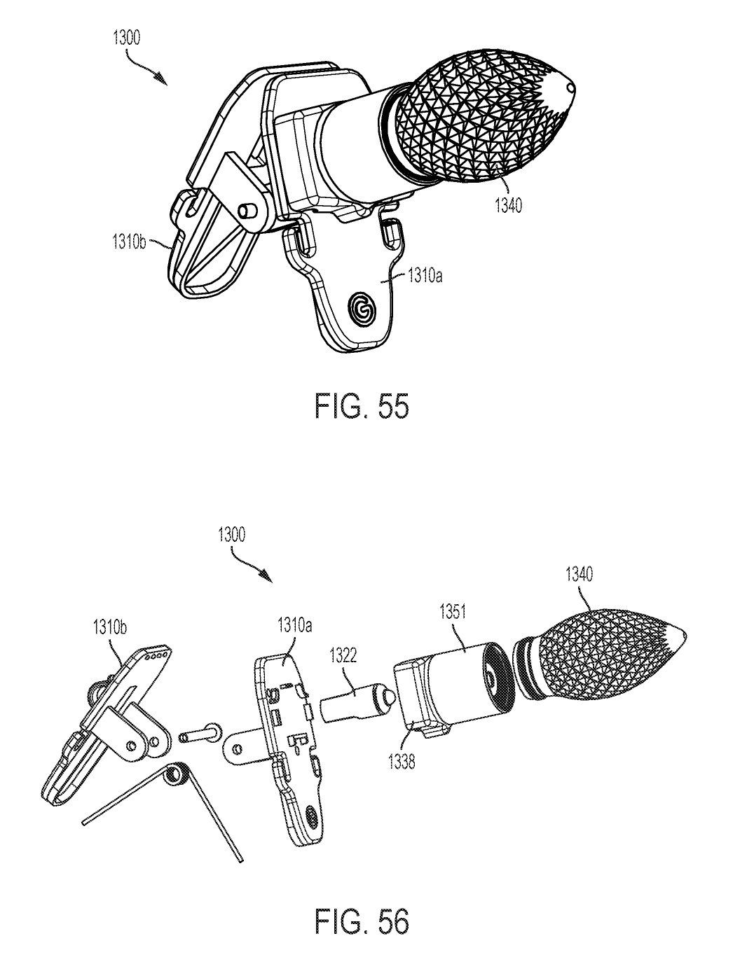

FIGS. 55-59 depict a thirteenth embodiment of a clip light 1300 according to the present invention. FIG. 55 shows a perspective view of clip light 1300. Clip light 1300 can have first and second clamp members 1310a, 1310b that are connected together in the form of a hinge, and operate in a similar manner as previous embodiments. Lens 1340, such as a kaleidoscope lens, can illuminate the light from the clip light 1300. Clip light 1300 is similar to the clip light 600 of the sixth embodiment, except for differences described Here, the clip light 1300 can include a pluggable LED 1322 that is configured to stand upright inside the light unit covers 1338, 1351. The pluggable LED 1322 can be inserted into a lamp holder located on the clip 1302. Referring to FIG. 56, the light unit cover 1338 can be connected to the first clamp member 1310a, for example, using snap connectors, adhesives, or other structures known in the art. The cover 1338 can include a protruding receptacle 1351 that is configured to receive the LED 1322. In some embodiments, LED 1322 can be plugged into and through the protruding receptacle 1351. The lens 1340 can attach to the protruding receptacle 1351, for example, using mating threads. The protruding receptacle 1351 can distribute light to the lens 1340, which can comprise a beam splitting kaleidoscope lens. In some embodiments, the protruding receptacle 1351 is opaque, so as to prevent light transmission. As can be seen from FIG. 56, the lens 1340 can be an elongated, candle-shaped bulb having a plurality of light-diffracting facets.

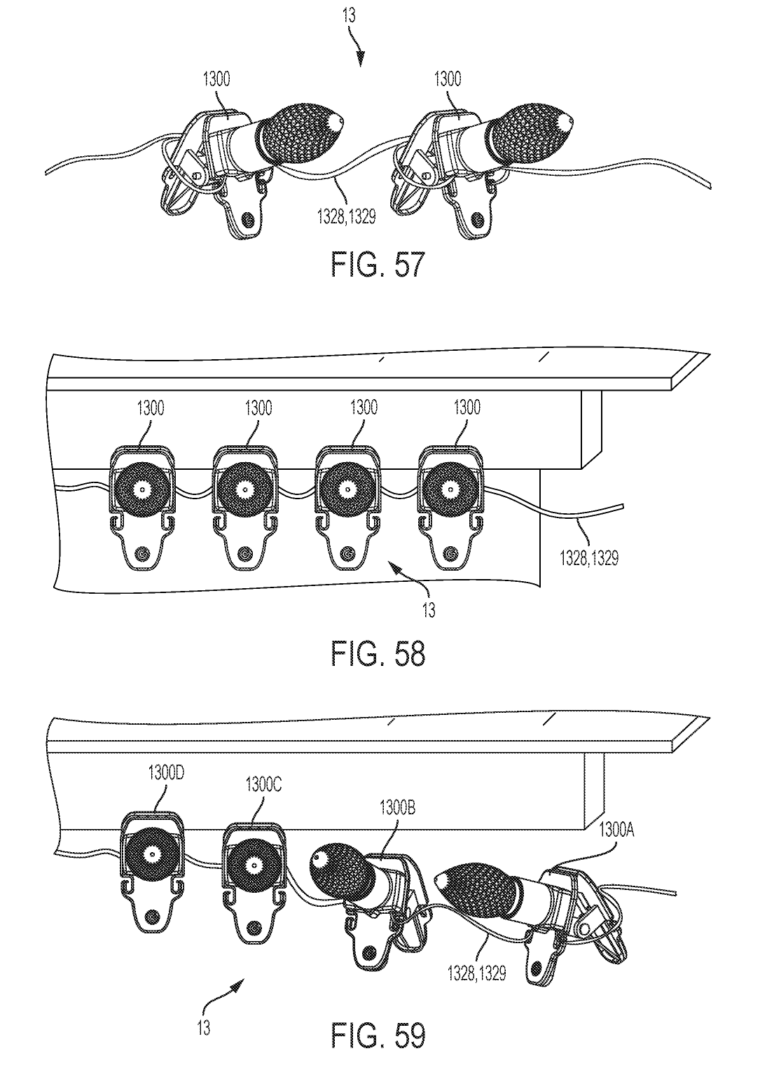

FIG. 57 shows a lighting system 13 including a chain of clip lights 1300 connected by one or more wires, 1328, 1329. The one or more wires 1328, 1329 can proceed in and out of cover 1338 in order to connect to the LED 1322, for example, by holes located in the cover. The wires can supply power and control of the LED 1322. FIG. 58 shows the chain of clip lights 1300 mounted to a structure 1390, such as a fascia board. FIG. 59 shows a progression of the state of the clip lights with clip lights 1300A and 1300B being in a relaxed, closed state, clip lights 1300C being in a more open, more expanded state, and clip light 1300D being in a mounted state.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A clip light, comprising:
a clip having a first clamp member and a second clamp member that opposes the first clamp member, wherein the first clamp member and the second clamp member are elastically biased towards one another;
a housing mounted on the first clamp member, the housing defining a hole;
a light emitting diode located in the housing; and
a window that covers the light emitting diode and the hole in the housing.

2. The clip light of claim 1, further comprising an elastic member that biases the first clamp member towards the second clamp member.

3. The clip light of claim 1, further comprising a circuit board, located within the housing.

4. The clip light of claim 1, wherein the window comprises a lens, and the light emitting diode projects light through the lens.

5. The clip light of claim 4, wherein the lens comprises a beam-splitting kaleidoscope lens.

6. (canceled)

7. The clip light of claim 1, wherein the light emitting diode is capsule-shaped.

8. The clip light of claim 1, wherein the light emitting diode is surfaced mounted onto a printed circuit board.

9. (canceled)

10. (canceled)

11. (canceled)

12. (canceled)

13. A lighting system comprising:
a plurality of the clip lights of claim 1, arranged into a light string by wires;
a power adapter that transmits power to the plurality of clip lights through the wires; and
a set of wires that connects the plurality of clip lights to the power adapter.

14. The lighting system of claim 13, further comprising a controller that is connected to the light string and modulates power to the clip lights.

15. The lighting system of claim 14, wherein the controller is part of the power adapter.

16. The lighting system of claim 14, wherein the controller communicates wirelessly with the power adapter.
